(19) United States
(12) Patent Application Publication
(10) Pub. No.: US 2025/0053496 A1
(43) Pub. Date: Feb. 13, 2025

(54) METHODS AND SYSTEMS FOR DETECTING AND CORRECTING TRENDING PROBLEMS WITH APPLICATIONS USING LANGUAGE MODELS

(71) Applicant: VMware, Inc., Palo Alto, CA (US)

(72) Inventors: Ashot Baghdasaryan, Yerevan (AM); Tigran Bunarjyan, Yerevan (AM); Arnak Poghosyan, Yerevan (AM); Ashot Nshan Harutyunyan, Yerevan (AM); Jad El-Zein, Yerevan (AM)

(73) Assignee: VMware, Inc., Palo Alto, CA (US)

(21) Appl. No.: 18/232,743

(22) Filed: Aug. 10, 2023

(51) Int. Cl. G06F 11/36; G06N 5/022

(52) U.S. Cl. CPC G06F 11/3608; G06F 11/3664; G06N 5/022

(57) ABSTRACT

This disclosure is directed to automated computer-implemented methods and systems for detecting and correcting a trending problem with an application executing in a data center. The methods receive a new support request entered via a graphical user interface. The methods perform trend discovery of the new support request over recent time windows using a pre-trained and fine-tuned model bidirectional encoder representation from transformer. In response to detecting a trending problem described in the new support request, the method discovers recommended remedial measures for the new support request based on similar support requests previously recorded in a support request data store or on similar knowledge base articles previously recorded in a knowledge base data store. The recommended remedial measures for correcting the trending problem are executed using an operations manager of the data center.

### TECHNICAL FIELD

This disclosure is directed to methods and systems for resolving problems with applications executing in large distributed computing environments.

### BACKGROUND

Electronic computing has evolved from primitive, vacuum-tube-based computer systems, initially developed during the 1940s, to modern electronic computing systems in which large numbers of multi-processor computer systems, such as server computers and workstations, are networked together with large-capacity data-storage devices to produce geographically distributed computing systems that provide enormous computational bandwidths and data-storage capacities. These large, distributed computing systems include data centers and are made possible by advancements in virtualization, computer networking, distributed operating systems and applications, data-storage appliances, computer hardware, and software technologies. The number and size of data centers have grown in recent years to meet the increasing demand for information technology (“IT”) services, such as running applications for organizations that provide business services, web services, streaming services, and other cloud services to millions of users each day.

Advancements in virtualization and software technologies have paved the way for software service providers to run their applications in data centers and offer software as a service (“SaaS”) to end users over the internet. SaaS is a licensing and software distribution model in which services of an application are licensed to end users over the internet via any device with a network or internet connection. SaaS is a widely used delivery model for many applications, such as office software, messaging software, payroll processing software, database management system software, management software, development software, entertainment streaming, and gaming. A software provider may host their application and related data storage in their own data center, or the software provider may contract with a cloud service provider to host their application in the provider's data center. A SaaS application is typically deployed as a single instance that runs on server computers in a data center, and that single instance serves each end user with the data of each end user stored separately. As a result, end users of SaaS applications are not tasked with the setup and maintenance of the applications. Each end user simply pays a subscription fee to and/or enters a licensing agreement with the software service provider to gain access to the services provided by the application.

Timely identification and resolution of application problems are of particular importance to software service providers. Trending problems are of much higher are of much higher priority than isolated issues because trending problems are typically a sign of a persistent problem experienced by large numbers of end users. Software services providers cannot afford prolonged service disruptions. Trending problems frustrate much larger numbers of end users than isolated issues, damage the reputation of the software service provider, and may cause end users to switch to similar services provided by another software service provider.

To address end user issues and concerns, software service providers rely on ticking systems that allow end users to report incidents in the form of support request (“SR”) tickets, or simply SRs, to customer support teams of the software service providers. Every SR received by the ticketing system is created with a unique ID that allows the support team of the software service provider to track the status of each SR. When the concern or issue is resolved, the SR is closed. Cloud service providers have developed data center operation management tools to aid system administrators and software service with responding to SRs. However, due to increasingly high numbers of SRs logged each day, typical management tools are not able to effectively identify trending issues. For continuous enhancement of proactive support capabilities especially for SaaS applications, it has become significant to isolate and detect trending problems as valuable evidence for longer-term resolution strategies of trending issues. Software service providers seek methods and systems to discover and track the development of trending issues to rapidly resolve issues in terms of explainable rules for applying remedial measures.

### SUMMARY

This disclosure is directed to automated computer-implemented methods and systems for detecting and correcting a trending problem with an application executing in a data center. The methods receive a new support request entered via a graphical user interface (“GUI”). The methods perform trend discovery of the new support request over recent time windows using a pre-trained and fine-tuned model bidirectional encoder representation from transformer (“vsBERT”). In response to detecting a trending problem described in the new support request, the method discovers recommended remedial measures for the new support request based on similar support requests previously recorded in a support request data store or on similar knowledge base articles previously recorded in a knowledge base data store. The recommended remedial measures for correcting the trending problem are executed using an operations manager of the data center. User feedback regarding the end user's satisfaction with executing the recommended remedial measure to resolve the trending problem. The user feedback is used to fine tune the recommended remedial measures.

### DESCRIPTION OF THE DRAWINGS

FIG. 1 shows an architectural diagram for various types of computers.

FIG. 2 shows an Internet-connected distributed computer system.

FIG. 3 shows cloud computing.

FIG. 4 shows generalized hardware and software components of a general-purpose computer system.

FIGS. 5A-5B show two types of virtual machines (“VMs”) and VM execution environments.

FIG. 6 shows an example of an open virtualization format package.

FIG. 7 shows examples of virtual data centers provided as an abstraction of underlying physical-data-center hardware components.

FIG. 8 shows virtual-machine components of a virtual-data-center management server and physical servers of a physical data center.

FIG. 9 shows a cloud-director level of abstraction.

FIG. 10 shows virtual-cloud-connector nodes.

FIG. 11 shows an example server computer used to host three containers.

FIG. 12 shows an approach to implementing containers on a VM.

FIG. 13 shows an example of an application that provides software as a service (“SaaS”) to multiple devices over the internet.

FIG. 14 shows an example of a support manager that receives and storing support requests (“SRs”) and knowledge base (“KB”) articles.

FIGS. 15A-15B show an example of a support manager graphical user interface (“GUI”) for receiving SRs.

FIG. 15C shows example SRs stored as documents in an SR data store.

FIG. 16A shows an example of a support manager GUI for receiving a KB article.

FIG. 16B shows example KB stored as a document in a KB data store.

FIGS. 17A-17B show tables of examples of regular expressions designed to match particular character strings.

FIGS. 18A-18H show the steps of tokenizing an example SR.

FIG. 19 shows an example of forming a count vector for an SR based on a set of tokens of the SR.

FIG. 20 shows a table of frequencies of tokens of each SR in a corpus of SRs stored in the SR data store.

FIG. 21 shows a table of term frequency-inverse document frequency (“tf-idf”) of tokens of each SR in the SR data store.

FIG. 22 shows a table of tf-idfs of the tokens of each KB article in the KB data store.

FIG. 23 shows an example of using a pre-trained and fine-tuned model bidirectional encoder representation from transformer (“vsBERT”) to compute a feature vector from a token embedding of an SR.

FIGS. 24A-24B show an example of using cosine similarity to determine similar SRs.

FIGS. 25A-25B show an example of using cosine similarity to determine KB articles that are similar to an SR.

FIG. 26 shows an example of updating SR feature vectors data store, KB feature vectors data store, model weights data store of vsBERT, and a database of SR-KB similarity predictions.

FIG. 27 shows types of information stored in the SR feature vectors data store, KB feature vectors data store, and the SR-KB prediction data store.

FIG. 28 shows an example of a recent time window in which SRs are received.

FIG. 29 shows an example plot of five clusters of feature vectors.

FIG. 30 shows an example of a neighborhood of a feature vector.

FIGS. 31A-31C show examples of a core feature vector, a border feature vector, and noise, respectively.

FIG. 32 shows an example of a density reachable feature vector.

FIG. 33 shows an example plot of three clusters of feature vectors.

FIG. 34 shows a GUI of the support manager that displays an alert identifying a problem as trending and repeats the support request.

FIG. 35 shows a GUI of the support manager that displays a message identifying a previously unidentified trending problem.

FIG. 36 shows an example of user feedback information recorded for different recommended remedial measures associated with similar SRs and KB articles to a trending problem.

FIG. 37 is a flow diagram of a method for computing normalized discounted cumulative gain score for a recommended remedial measure.

FIG. 38 is a flow diagram of a method for detecting and correcting a trending problem with an application executed in data center.

FIG. 39 is a flow diagram of the “perform trend discovery of the new support request” procedure performed in FIG. 38.

FIG. 40 is a flow diagram of the “preprocess the new support request to obtain word embeddings” procedure performed in FIG. 39.

FIG. 41 is a flow diagram of the “determine number of similar support requests over recent time window” performed in FIG. 39.

FIG. 42 is a flow diagram of the “discover recommended remedial measures for the new support request” performed in FIG. 38.

### DETAILED DESCRIPTION

This disclosure presents automated computer-implemented methods and systems for detecting and correcting a trending problem with an application using language processing executing in a data center In the first subsection, computer hardware, complex computational systems, and virtualization are described. Computer-implemented methods and systems for detecting and correcting trending problems with applications using language processing are described in a second subsection.

### Computer Hardware, Complex Computational Systems, and Virtualization

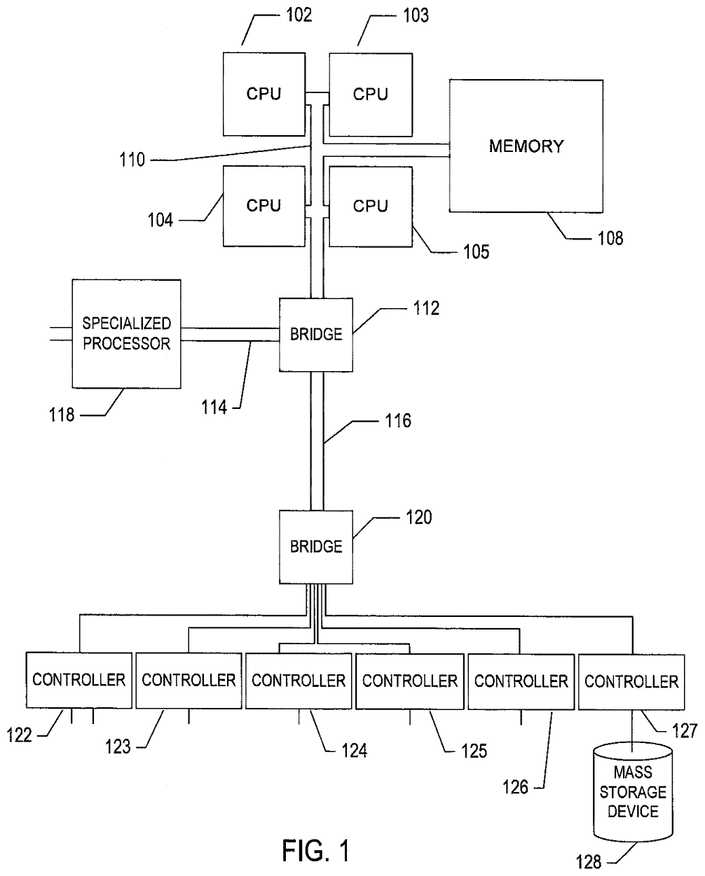

FIG. 1 shows a general architectural diagram for various types of computers. Computers that receive, process, and store log messages may be described by the general architectural diagram shown in FIG. 1, for example. The computer system contains one or multiple central processing units (“CPUs”) 102-105, one or more electronic memories 108 interconnected with the CPUs by a CPU/memory-subsystem bus 110 or multiple busses, a first bridge 112 that interconnects the CPU/memory-subsystem bus 110 with additional busses 114 and 116, or other types of high-speed interconnection media, including multiple, high-speed serial interconnects. These busses or serial interconnections, in turn, connect the CPUs and memory with specialized processors, such as a graphics processor 118, and with one or more additional bridges 120, which are interconnected with high-speed serial links or with multiple controllers 122-127, such as controller 127, that provide access to various different types of mass-storage devices 128, electronic displays, input devices, and other such components, subcomponents, and computational devices. It should be noted that computer-readable data-storage devices include optical and electromagnetic disks, electronic memories, and other physical data-storage devices.

Of course, there are many different types of computer-system architectures that differ from one another in the number of different memories, including different types of hierarchical cache memories, the number of processors and the connectivity of the processors with other system components, the number of internal communications busses and serial links, and in many other ways. However, computer systems generally execute stored programs by fetching instructions from memory and executing the instructions in one or more processors. Computer systems include general-purpose computer systems, such as personal computers (“PCs”), various types of server computers and workstations, and higher-end mainframe computers, but may also include a plethora of various types of special-purpose computing devices, including data-storage systems, communications routers, network nodes, tablet computers, and mobile telephones.

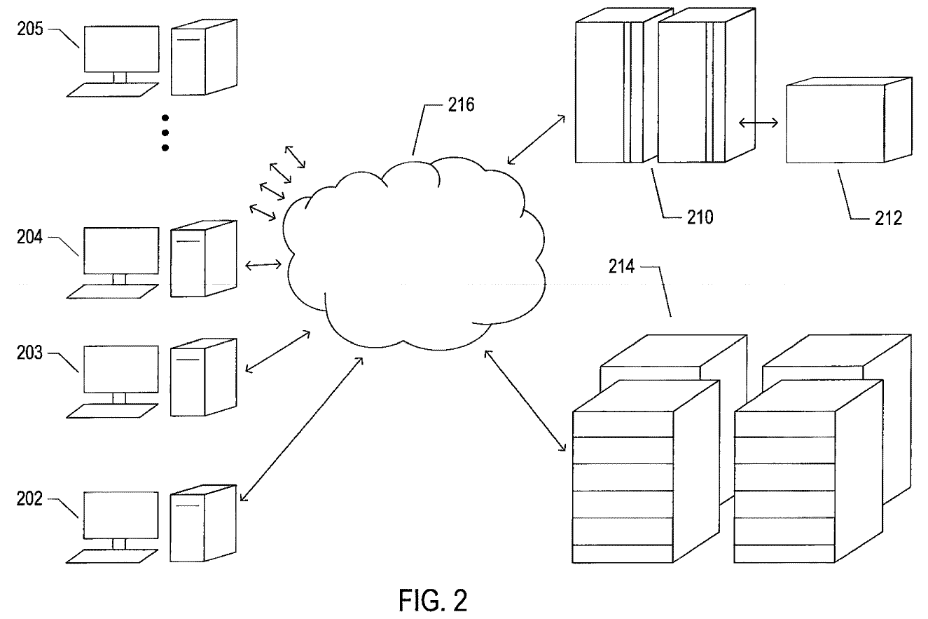

FIG. 2 shows an Internet-connected distributed computer system. As communications and networking technologies have evolved in capability and accessibility, and as the computational bandwidths, data-storage capacities, and other capabilities and capacities of various types of computer systems have steadily and rapidly increased, much of modern computing now generally involves large distributed systems and computers interconnected by local networks, wide-area networks, wireless communications, and the Internet. FIG. 2 shows a typical distributed system in which a large number of PCs 202-205, a high-end distributed mainframe system 210 with a large data-storage system 212, and a large computer center 214 with large numbers of rack-mounted server computers or blade servers all interconnected through various communications and networking systems that together comprise the Internet 216. Such distributed computing systems provide diverse arrays of functionalities. For example, a PC user may access hundreds of millions of different web sites provided by hundreds of thousands of different web servers throughout the world and may access high-computational-bandwidth computing services from remote computer facilities for running complex computational tasks.

Until recently, computational services were generally provided by computer systems and data centers purchased, configured, managed, and maintained by service-provider organizations. For example, an e-commerce retailer generally purchased, configured, managed, and maintained a data center including numerous web server computers, back-end computer systems, and data-storage systems for serving web pages to remote customers, receiving orders through the web-page interface, processing the orders, tracking completed orders, and other myriad different tasks associated with an e-commerce enterprise.

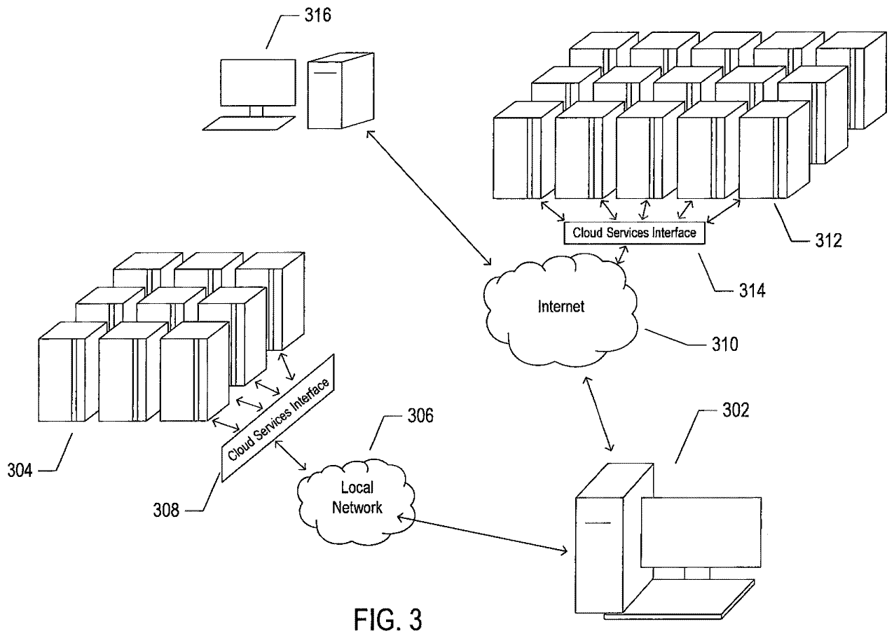

FIG. 3 shows cloud computing. In the recently developed cloud-computing paradigm, computing cycles and data-storage facilities are provided to organizations and individuals by cloud-computing providers. In addition, larger organizations may elect to establish private cloud-computing facilities in addition to, or instead of, subscribing to computing services provided by public cloud-computing service providers. In FIG. 3, a system administrator for an organization, using a PC 302, accesses the organization's private cloud 304 through a local network 306 and private-cloud interface 308 and accesses, through the Internet 310, a public cloud 312 through a public-cloud services interface 314. The administrator can, in either the case of the private cloud 304 or public cloud 312, configure virtual computer systems and even entire virtual data centers and launch execution of application programs on the virtual computer systems and virtual data centers in order to carry out any of many different types of computational tasks. As one example, a small organization may configure and run a virtual data center within a public cloud that executes web servers to provide an e-commerce interface through the public cloud to remote customers of the organization, such as a user viewing the organization's e-commerce web pages on a remote user system 316.

Cloud-computing facilities are intended to provide computational bandwidth and data-storage services much as utility companies provide electrical power and water to consumers. Cloud computing provides enormous advantages to small organizations without the devices to purchase, manage, and maintain in-house data centers. Such organizations can dynamically add and delete virtual computer systems from their virtual data centers within public clouds in order to track computational-bandwidth and data-storage needs, rather than purchasing sufficient computer systems within a physical data center to handle peak computational-bandwidth and data-storage demands. Moreover, small organizations can completely avoid the overhead of maintaining and managing physical computer systems, including hiring and periodically retraining information-technology specialists and continuously paying for operating-system and database-management-system upgrades. Furthermore, cloud-computing interfaces allow for easy and straightforward configuration of virtual computing facilities, flexibility in the types of applications and operating systems that can be configured, and other functionalities that are useful even for owners and administrators of private cloud-computing facilities used by a single organization.

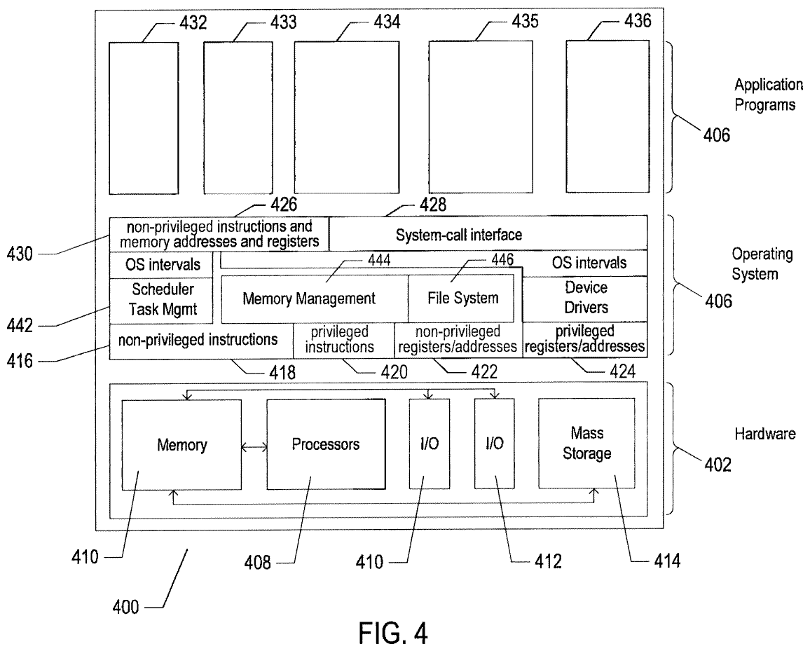

FIG. 4 shows generalized hardware and software components of a general-purpose computer system, such as a general-purpose computer system having an architecture similar to that shown in FIG. 1. The computer system 400 is often considered to include three fundamental layers: (1) a hardware layer or level 402; (2) an operating-system layer or level 404; and (3) an application-program layer or level 406. The hardware layer 402 includes one or more processors 408, system memory 410, various different types of input-output (“I/O”) devices 410 and 412, and mass-storage devices 414. Of course, the hardware level also includes many other components, including power supplies, internal communications links and busses, specialized integrated circuits, many different types of processor-controlled or microprocessor-controlled peripheral devices and controllers, and many other components. The operating system 404 interfaces to the hardware level 402 through a low-level operating system and hardware interface 416 generally comprising a set of non-privileged computer instructions 418, a set of privileged computer instructions 420, a set of non-privileged registers and memory addresses 422, and a set of privileged registers and memory addresses 424. In general, the operating system exposes non-privileged instructions, non-privileged registers, and non-privileged memory addresses 426 and a system-call interface 428 as an operating-system interface 430 to application programs 432-436 that execute within an execution environment provided to the application programs by the operating system. The operating system, alone, accesses the privileged instructions, privileged registers, and privileged memory addresses. By reserving access to privileged instructions, privileged registers, and privileged memory addresses, the operating system can ensure that application programs and other higher-level computational entities cannot interfere with one another's execution and cannot change the overall state of the computer system in ways that could deleteriously impact system operation. The operating system includes many internal components and modules, including a scheduler 442, memory management 444, a file system 446, device drivers 448, and many other components and modules. To a certain degree, modern operating systems provide numerous levels of abstraction above the hardware level, including virtual memory, which provides to each application program and other computational entities a separate, large, linear memory-address space that is mapped by the operating system to various electronic memories and mass-storage devices. The scheduler orchestrates interleaved execution of various different application programs and higher-level computational entities, providing to each application program a virtual, stand-alone system devoted entirely to the application program. From the application program's standpoint, the application program executes continuously without concern for the need to share processor devices and other system devices with other application programs and higher-level computational entities. The device drivers abstract details of hardware-component operation, allowing application programs to employ the system-call interface for transmitting and receiving data to and from communications networks, mass-storage devices, and other I/O devices and subsystems. The file system 446 facilitates abstraction of mass-storage-device and memory devices as a high-level, easy-to-access, file-system interface. Thus, the development and evolution of the operating system has resulted in the generation of a type of multi-faceted virtual execution environment for application programs and other higher-level computational entities.

While the execution environments provided by operating systems have proved to be an enormously successful level of abstraction within computer systems, the operating-system-provided level of abstraction is nonetheless associated with difficulties and challenges for developers and users of application programs and other higher-level computational entities. One difficulty arises from the fact that there are many different operating systems that run within various different types of computer hardware. In many cases, popular application programs and computational systems are developed to run on only a subset of the available operating systems and can therefore be executed within only a subset of the different types of computer systems on which the operating systems are designed to run. Often, even when an application program or other computational system is ported to additional operating systems, the application program or other computational system can nonetheless run more efficiently on the operating systems for which the application program or other computational system was originally targeted. Another difficulty arises from the increasingly distributed nature of computer systems. Although distributed operating systems are the subject of considerable research and development efforts, many of the popular operating systems are designed primarily for execution on a single computer system. In many cases, it is difficult to move application programs, in real time, between the different computer systems of a distributed computer system for high-availability, fault-tolerance, and load-balancing purposes. The problems are even greater in heterogeneous distributed computer systems which include different types of hardware and devices running different types of operating systems. Operating systems continue to evolve, as a result of which certain older application programs and other computational entities may be incompatible with more recent versions of operating systems for which they are targeted, creating compatibility issues that are particularly difficult to manage in large distributed systems.

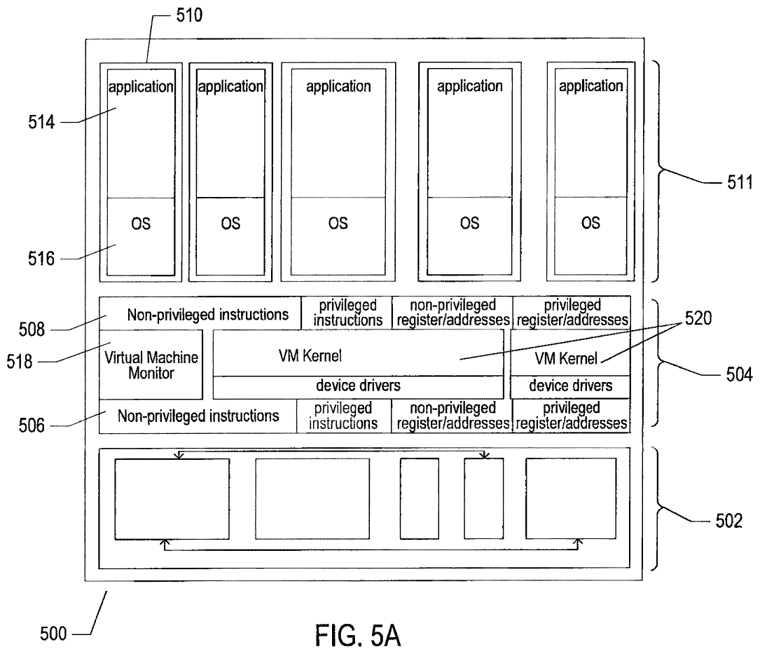

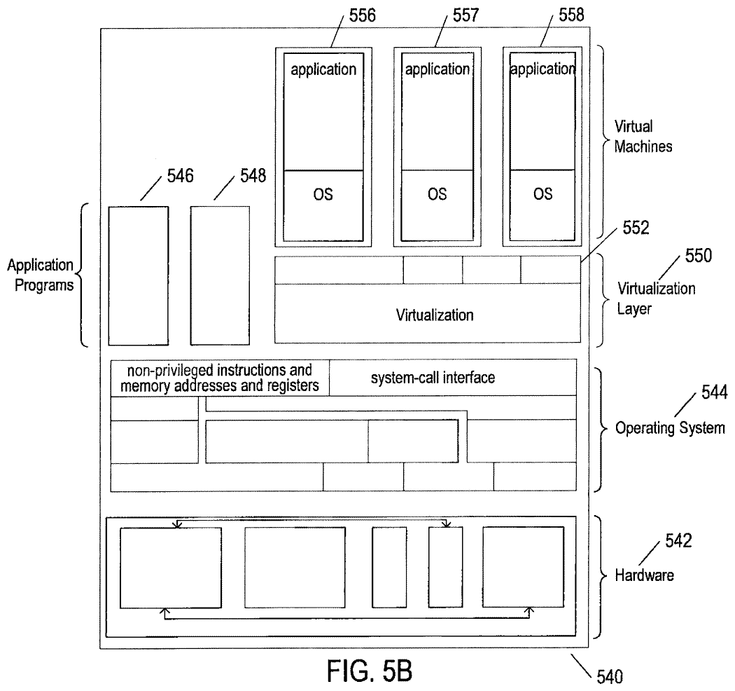

For all of these reasons, a higher level of abstraction, referred to as the “virtual machine,” (“VM”) has been developed and evolved to further abstract computer hardware in order to address many difficulties and challenges associated with traditional computing systems, including the compatibility issues discussed above. FIGS. 5A-B show two types of VM and virtual-machine execution environments. FIGS. 5A-B use the same illustration conventions as used in FIG. 4. FIG. 5A shows a first type of virtualization. The computer system 500 in FIG. 5A includes the same hardware layer 502 as the hardware layer 402 shown in FIG. 4. However, rather than providing an operating system layer directly above the hardware layer, as in FIG. 4, the virtualized computing environment shown in FIG. 5A features a virtualization layer 504 that interfaces through a virtualization-layer/hardware-layer interface 506, equivalent to interface 416 in FIG. 4, to the hardware. The virtualization layer 504 provides a hardware-like interface to VMs, such as VM 510, in a virtual-machine layer 511 executing above the virtualization layer 504. Each VM includes one or more application programs or other higher-level computational entities packaged together with an operating system, referred to as a “guest operating system,” such as application 514 and guest operating system 516 packaged together within VM 510. Each VM is thus equivalent to the operating-system layer 404 and application-program layer 406 in the general-purpose computer system shown in FIG. 4. Each guest operating system within a VM interfaces to the virtualization layer interface 504 rather than to the actual hardware interface 506. The virtualization layer 504 partitions hardware devices into abstract virtual-hardware layers to which each guest operating system within a VM interfaces. The guest operating systems within the VMs, in general, are unaware of the virtualization layer and operate as if they were directly accessing a true hardware interface. The virtualization layer 504 ensures that each of the VMs currently executing within the virtual environment receive a fair allocation of underlying hardware devices and that all VMs receive sufficient devices to progress in execution. The virtualization layer 504 may differ for different guest operating systems. For example, the virtualization layer is generally able to provide virtual hardware interfaces for a variety of different types of computer hardware. This allows, as one example, a VM that includes a guest operating system designed for a particular computer architecture to run on hardware of a different architecture. The number of VMs need not be equal to the number of physical processors or even a multiple of the number of processors.

The virtualization layer 504 includes a virtual-machine-monitor module 518 (“VMM”) that virtualizes physical processors in the hardware layer to create virtual processors on which each of the VMs executes. For execution efficiency, the virtualization layer attempts to allow VMs to directly execute non-privileged instructions and to directly access non-privileged registers and memory. However, when the guest operating system within a VM accesses virtual privileged instructions, virtual privileged registers, and virtual privileged memory through the virtualization layer 504, the accesses result in execution of virtualization-layer code to simulate or emulate the privileged devices. The virtualization layer additionally includes a kernel module 520 that manages memory, communications, and data-storage machine devices on behalf of executing VMs (“VM kernel”). The VM kernel, for example, maintains shadow page tables on each VM so that hardware-level virtual-memory facilities can be used to process memory accesses. The VM kernel additionally includes routines that implement virtual communications and data-storage devices as well as device drivers that directly control the operation of underlying hardware communications and data-storage devices. Similarly, the VM kernel virtualizes various other types of I/O devices, including keyboards, optical-disk drives, and other such devices. The virtualization layer 504 essentially schedules execution of VMs much like an operating system schedules execution of application programs, so that the VMs each execute within a complete and fully functional virtual hardware layer.

FIG. 5B shows a second type of virtualization. In FIG. 5B, the computer system 540 includes the same hardware layer 542 and operating system layer 544 as the hardware layer 402 and the operating system layer 404 shown in FIG. 4. Several application programs 546 and 548 are shown running in the execution environment provided by the operating system 544. In addition, a virtualization layer 550 is also provided, in computer 540, but, unlike the virtualization layer 504 discussed with reference to FIG. 5A, virtualization layer 550 is layered above the operating system 544, referred to as the “host OS.” and uses the operating system interface to access operating-system-provided functionality as well as the hardware. The virtualization layer 550 comprises primarily a VMM and a hardware-like interface 552, similar to hardware-like interface 508 in FIG. 5A. The hardware-layer interface 552, equivalent to interface 416 in FIG. 4, provides an execution environment for a number of VMs 556-558, each including one or more application programs or other higher-level computational entities packaged together with a guest operating system.

In FIGS. 5A-5B, the layers are somewhat simplified for clarity of illustration. For example, portions of the virtualization layer 550 may reside within the host-operating-system kernel, such as a specialized driver incorporated into the host operating system to facilitate hardware access by the virtualization layer.

It should be noted that virtual hardware layers, virtualization layers, and guest operating systems are all physical entities that are implemented by computer instructions stored in physical data-storage devices, including electronic memories, mass-storage devices, optical disks, magnetic disks, and other such devices. The term “virtual” does not, in any way, imply that virtual hardware layers, virtualization layers, and guest operating systems are abstract or intangible. Virtual hardware layers, virtualization layers, and guest operating systems execute on physical processors of physical computer systems and control operation of the physical computer systems, including operations that alter the physical states of physical devices, including electronic memories and mass-storage devices. They are as physical and tangible as any other component of a computer since, such as power supplies, controllers, processors, busses, and data-storage devices.

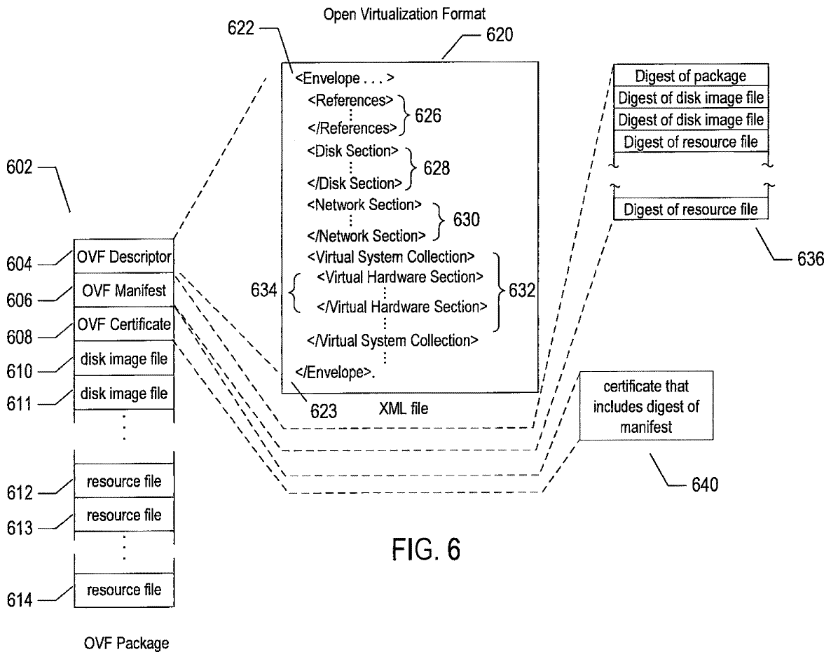

A VM or virtual application, described below, is encapsulated within a data package for transmission, distribution, and loading into a virtual-execution environment. One public standard for virtual-machine encapsulation is referred to as the “open virtualization format” (“OVF”). The OVF standard specifies a format for digitally encoding a VM within one or more data files. FIG. 6 shows an OVF package. An OVF package 602 includes an OVF descriptor 604, an OVF manifest 606, an OVF certificate 608, one or more disk-image files 610-611, and one or more device files 612-614. The OVF package can be encoded and stored as a single file or as a set of files. The OVF descriptor 604 is an XML document 620 that includes a hierarchical set of elements, each demarcated by a beginning tag and an ending tag. The outermost, or highest-level, element is the envelope element, demarcated by tags 622 and 623. The next-level element includes a reference element 626 that includes references to all files that are part of the OVF package, a disk section 628 that contains meta information about all of the virtual disks included in the OVF package, a network section 630 that includes meta information about all of the logical networks included in the OVF package, and a collection of virtual-machine configurations 632 which further includes hardware descriptions of each VM 634. There are many additional hierarchical levels and elements within a typical OVF descriptor. The OVF descriptor is thus a self-describing, XML file that describes the contents of an OVF package. The OVF manifest 606 is a list of cryptographic-hash-function-generated digests 636 of the entire OVF package and of the various components of the OVF package. The OVF certificate 608 is an authentication certificate 640 that includes a digest of the manifest and that is cryptographically signed. Disk image files, such as disk image file 610, are digital encodings of the contents of virtual disks and device files 612 are digitally encoded content, such as operating-system images. A VM or a collection of VMs encapsulated together within a virtual application can thus be digitally encoded as one or more files within an OVF package that can be transmitted, distributed, and loaded using well-known tools for transmitting, distributing, and loading files. A virtual appliance is a software service that is delivered as a complete software stack installed within one or more VMs that is encoded within an OVF package.

The advent of VMs and virtual environments has alleviated many of the difficulties and challenges associated with traditional general-purpose computing. Machine and operating-system dependencies can be significantly reduced or eliminated by packaging applications and operating systems together as VMs and virtual appliances that execute within virtual environments provided by virtualization layers running on many different types of computer hardware. A next level of abstraction, referred to as virtual data centers or virtual infrastructure, provide a data-center interface to virtual data centers computationally constructed within physical data centers.

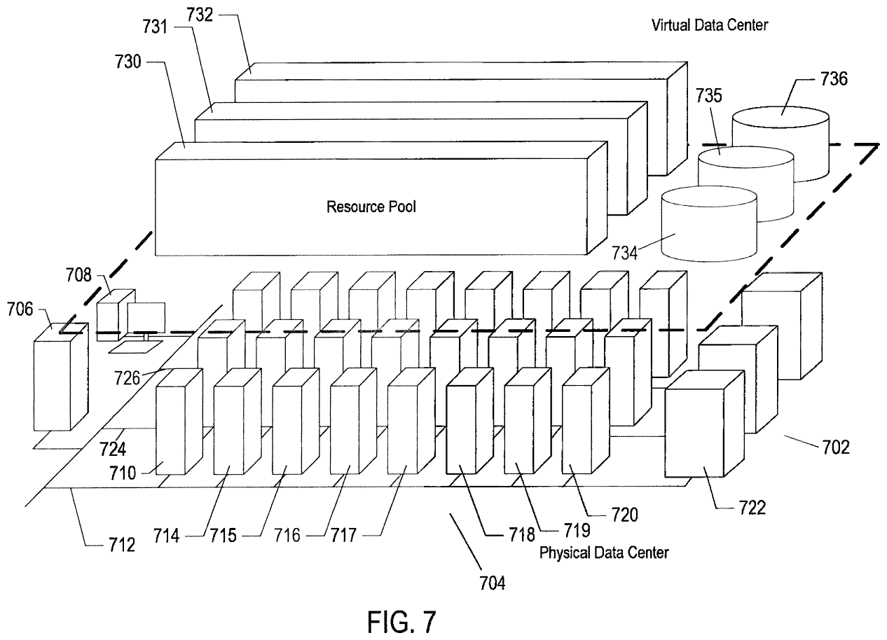

FIG. 7 shows virtual data centers provided as an abstraction of underlying physical-data-center hardware components. In FIG. 7, a physical data center 702 is shown below a virtual-interface plane 704. The physical data center consists of a virtual-data-center management server computer 706 and any of various different computers, such as PC 708, on which a virtual-data-center management interface may be displayed to system administrators and other users. The physical data center additionally includes generally large numbers of server computers, such as server computer 710, that are coupled together by local area networks, such as local area network 712 that directly interconnects server computer 710 and 714-720 and a mass-storage array 722. The physical data center shown in FIG. 7 includes three local area networks 712, 724, and 726 that each directly interconnects a bank of eight server computers and a mass-storage array. The individual server computers, such as server computer 710, each includes a virtualization layer and runs multiple VMs. Different physical data centers may include many different types of computers, networks, data-storage systems and devices connected according to many different types of connection topologies. The virtual-interface plane 704, a logical abstraction layer shown by a plane in FIG. 7, abstracts the physical data center to a virtual data center comprising one or more device pools, such as device pools 730-732, one or more virtual data stores, such as virtual data stores 734-736, and one or more virtual networks. In certain implementations, the device pools abstract banks of server computers directly interconnected by a local area network.

The virtual-data-center management interface allows provisioning and launching of VMs with respect to device pools, virtual data stores, and virtual networks, so that virtual-data-center administrators need not be concerned with the identities of physical-data-center components used to execute particular VMs. Furthermore, the virtual-data-center management server computer 706 includes functionality to migrate running VMs from one server computer to another in order to optimally or near optimally manage device allocation, provides fault tolerance, and high availability by migrating VMs to most effectively utilize underlying physical hardware devices, to replace VMs disabled by physical hardware problems and failures, and to ensure that multiple VMs supporting a high-availability virtual appliance are executing on multiple physical computer systems so that the services provided by the virtual appliance are continuously accessible, even when one of the multiple virtual appliances becomes compute bound, data-access bound, suspends execution, or fails. Thus, the virtual data center layer of abstraction provides a virtual-data-center abstraction of physical data centers to simplify provisioning, launching, and maintenance of VMs and virtual appliances as well as to provide high-level, distributed functionalities that involve pooling the devices of individual server computers and migrating VMs among server computers to achieve load balancing, fault tolerance, and high availability.

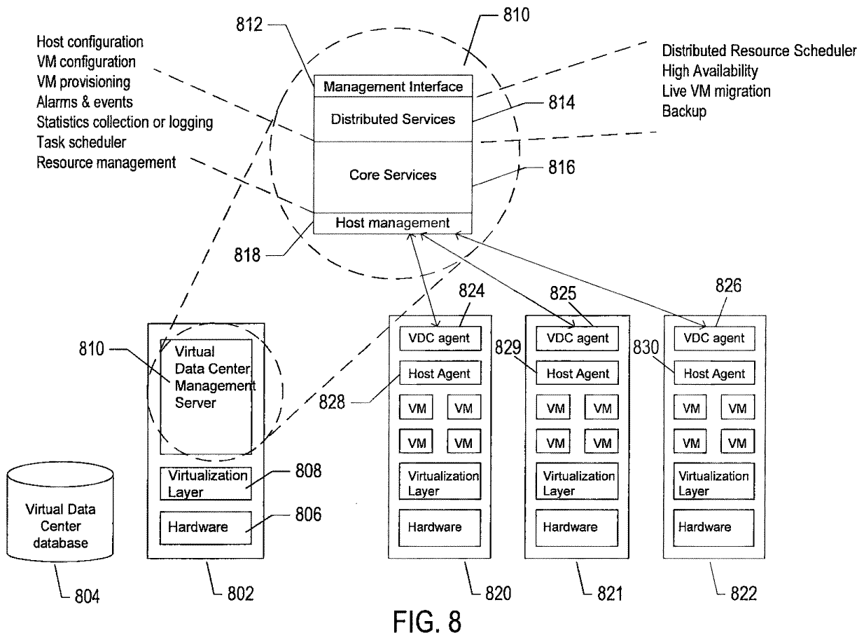

FIG. 8 shows virtual-machine components of a virtual-data-center management server computer and physical server computers of a physical data center above which a virtual-data-center interface is provided by the virtual-data-center management server computer. The virtual-data-center management server computer 802 and a virtual-data-center database 804 comprise the physical components of the management component of the virtual data center. The virtual-data-center management server computer 802 includes a hardware layer 806 and virtualization layer 808 and runs a virtual-data-center management-server VM 810 above the virtualization layer. Although shown as a single server computer in FIG. 8, the virtual-data-center management server computer (“VDC management server”) may include two or more physical server computers that support multiple VDC-management-server virtual appliances. The virtual-data-center management-server VM 810 includes a management-interface component 812, distributed services 814, core services 816, and a host-management interface 818. The host-management interface 818 is accessed from any of various computers, such as the PC 708 shown in FIG. 7. The host-management interface 818 allows the virtual-data-center administrator to configure a virtual data center, provision VMs, collect statistics and view log files for the virtual data center, and to carry out other, similar management tasks. The host-management interface 818 interfaces to virtual-data-center agents 824, 825, and 826 that execute as VMs within each of the server computers of the physical data center that is abstracted to a virtual data center by the VDC management server computer.

The distributed services 814 include a distributed-device scheduler that assigns VMs to execute within particular physical server computers and that migrates VMs in order to most effectively make use of computational bandwidths, data-storage capacities, and network capacities of the physical data center. The distributed services 814 further include a high-availability service that replicates and migrates VMs in order to ensure that VMs continue to execute despite problems and failures experienced by physical hardware components. The distributed services 814 also include a live-virtual-machine migration service that temporarily halts execution of a VM, encapsulates the VM in an OVF package, transmits the OVF package to a different physical server computer, and restarts the VM on the different physical server computer from a virtual-machine state recorded when execution of the VM was halted. The distributed services 814 also include a distributed backup service that provides centralized virtual-machine backup and restore.

The core services 816 provided by the VDC management server VM 810 include host configuration, virtual-machine configuration, virtual-machine provisioning, generation of virtual-data-center alerts and events, ongoing event logging and statistics collection, a task scheduler, and a device-management module. Each physical server computers 820-822 also includes a host-agent VM 828-830 through which the virtualization layer can be accessed via a virtual-infrastructure application programming interface (“API”). This interface allows a remote administrator or user to manage an individual server computer through the infrastructure API. The virtual-data-center agents 824-826 access virtualization-layer server information through the host agents. The virtual-data-center agents are primarily responsible for offloading certain of the virtual-data-center management-server functions specific to a particular physical server to that physical server computer. The virtual-data-center agents relay and enforce device allocations made by the VDC management server VM 810, relay virtual-machine provisioning and configuration-change commands to host agents, monitor and collect performance statistics, alerts, and events communicated to the virtual-data-center agents by the local host agents through the interface API, and to carry out other, similar virtual-data-management tasks.

The virtual-data-center abstraction provides a convenient and efficient level of abstraction for exposing the computational devices of a cloud-computing facility to cloud-computing-infrastructure users. A cloud-director management server exposes virtual devices of a cloud-computing facility to cloud-computing-infrastructure users. In addition, the cloud director introduces a multi-tenancy layer of abstraction, which partitions VDCs into tenant associated VDCs that can each be allocated to an individual tenant or tenant organization, both referred to as a “tenant.” A given tenant can be provided one or more tenant-associated VDCs by a cloud director managing the multi-tenancy layer of abstraction within a cloud-computing facility. The cloud services interface (308 in FIG. 3) exposes a virtual-data-center management interface that abstracts the physical data center.

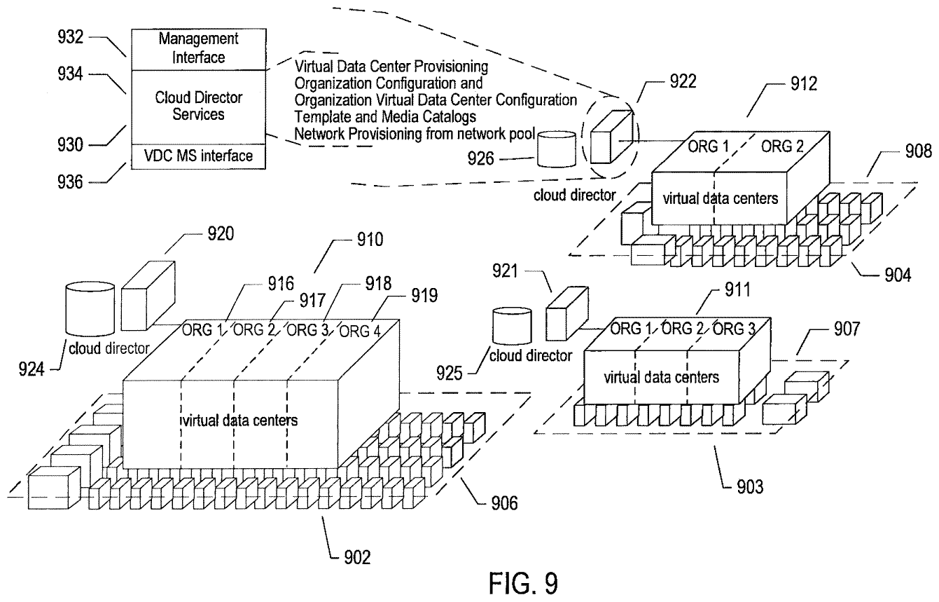

FIG. 9 shows a cloud-director level of abstraction. In FIG. 9, three different physical data centers 902-904 are shown below planes representing the cloud-director layer of abstraction 906-908. Above the planes representing the cloud-director level of abstraction, multi-tenant virtual data centers 910-912 are shown. The devices of these multi-tenant virtual data centers are securely partitioned in order to provide secure virtual data centers to multiple tenants, or cloud-services-accessing organizations. For example, a cloud-services-provider virtual data center 910 is partitioned into four different tenant-associated virtual-data centers within a multi-tenant virtual data center for four different tenants 916-919. Each multi-tenant virtual data center is managed by a cloud director comprising one or more cloud-director server computers 920-922 and associated cloud-director databases 924-926. Each cloud-director server computer or server computers runs a cloud-director virtual appliance 930 that includes a cloud-director management interface 932, a set of cloud-director services 934, and a virtual-data-center management-server interface 936. The cloud-director services include an interface and tools for provisioning multi-tenant virtual data center virtual data centers on behalf of tenants, tools and interfaces for configuring and managing tenant organizations, tools and services for organization of virtual data centers and tenant-associated virtual data centers within the multi-tenant virtual data center, services associated with template and media catalogs, and provisioning of virtualization networks from a network pool. Templates are VMs that each contains an OS and/or one or more VMs containing applications. A template may include much of the detailed contents of VMs and virtual appliances that are encoded within OVF packages, so that the task of configuring a VM or virtual appliance is significantly simplified, requiring only deployment of one OVF package. These templates are stored in catalogs within a tenant's virtual-data center. These catalogs are used for developing and staging new virtual appliances and published catalogs are used for sharing templates in virtual appliances across organizations. Catalogs may include OS images and other information relevant to construction, distribution, and provisioning of virtual appliances.

Considering FIGS. 7 and 9, the VDC-server and cloud-director layers of abstraction can be seen, as discussed above, to facilitate employment of the virtual-data-center concept within private and public clouds. However, this level of abstraction does not fully facilitate aggregation of single-tenant and multi-tenant virtual data centers into heterogeneous or homogeneous aggregations of cloud-computing facilities.

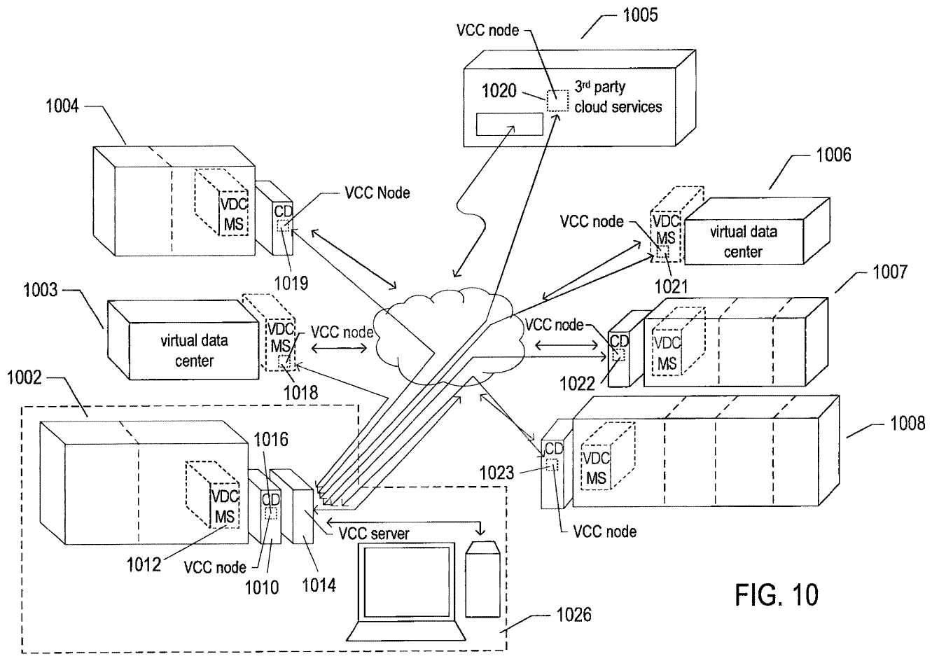

FIG. 10 shows virtual-cloud-connector nodes (“VCC nodes”) and a VCC server, components of a distributed system that provides multi-cloud aggregation and that includes a cloud-connector server and cloud-connector nodes that cooperate to provide services that are distributed across multiple clouds. VMware vCloud™ VCC servers and nodes are one example of VCC server and nodes. In FIG. 10, seven different cloud-computing facilities are shown 1002-1008. Cloud-computing facility 1002 is a private multi-tenant cloud with a cloud director 1010 that interfaces to a VDC management server 1012 to provide a multi-tenant private cloud comprising multiple tenant-associated virtual data centers. The remaining cloud-computing facilities 1003-1008 may be either public or private cloud-computing facilities and may be single-tenant virtual data centers, such as virtual data centers 1003 and 1006, multi-tenant virtual data centers, such as multi-tenant virtual data centers 1004 and 1007-1008, or any of various different kinds of third-party cloud-services facilities, such as third-party cloud-services facility 1005. An additional component, the VCC server 1014, acting as a controller is included in the private cloud-computing facility 1002 and interfaces to a VCC node 1016 that runs as a virtual appliance within the cloud director 1010. A VCC server may also run as a virtual appliance within a VDC management server that manages a single-tenant private cloud. The VCC server 1014 additionally interfaces, through the Internet, to VCC node virtual appliances executing within remote VDC management servers, remote cloud directors, or within the third-party cloud services 1018-1023. The VCC server provides a VCC server interface that can be displayed on a local or remote terminal. PC, or other computer system 1026 to allow a cloud-aggregation administrator or other user to access VCC-server-provided aggregate-cloud distributed services. In general, the cloud-computing facilities that together form a multiple-cloud-computing aggregation through distributed services provided by the VCC server and VCC nodes are geographically and operationally distinct.

As mentioned above, while the virtual-machine-based virtualization layers, described in the previous subsection, have received widespread adoption and use in a variety of different environments, from personal computers to enormous, distributed computing systems, traditional virtualization technologies are associated with computational overheads. While these computational overheads have steadily decreased, over the years, and often represent ten percent or less of the total computational bandwidth consumed by an application running above a guest operating system in a virtualized environment, traditional virtualization technologies nonetheless involve computational costs in return for the power and flexibility that they provide.

While a traditional virtualization layer can simulate the hardware interface expected by any of many different operating systems, OSL virtualization essentially provides a secure partition of the execution environment provided by a particular operating system. A container is an abstraction at the application layer that packages code and dependencies together. Multiple containers can run on the same computer system and share the operating system kernel, each container running as an isolated process in the user space. One or more containers are run in pods. For example, OSL virtualization provides a file system to each container, but the file system provided to the container is essentially a view of a partition of the general file system provided by the underlying operating system of the host. In essence, OSL virtualization uses operating-system features, such as namespace isolation, to isolate each container from the other containers running on the same host. In other words, namespace isolation ensures that each application is executed within the execution environment provided by a container to be isolated from applications executing within the execution environments provided by the other containers. The containers are isolated from one another and bundle their own software, libraries, and configuration files within in the pods. A container cannot access files that are not included in the container's namespace and cannot interact with applications running in other containers. As a result, a container can be booted up much faster than a VM, because the container uses operating-system-kernel features that are already available and functioning within the host. Furthermore, the containers share computational bandwidth, memory, network bandwidth, and other computational resources provided by the operating system, without the overhead associated with computational resources allocated to VMs and virtualization layers. Again, however, OSL virtualization does not provide many desirable features of traditional virtualization. As mentioned above, OSL virtualization does not provide a way to run different types of operating systems for different groups of containers within the same host and OSL-virtualization does not provide for live migration of containers between hosts, high-availability functionality, distributed resource scheduling, and other computational functionality provided by traditional virtualization technologies.

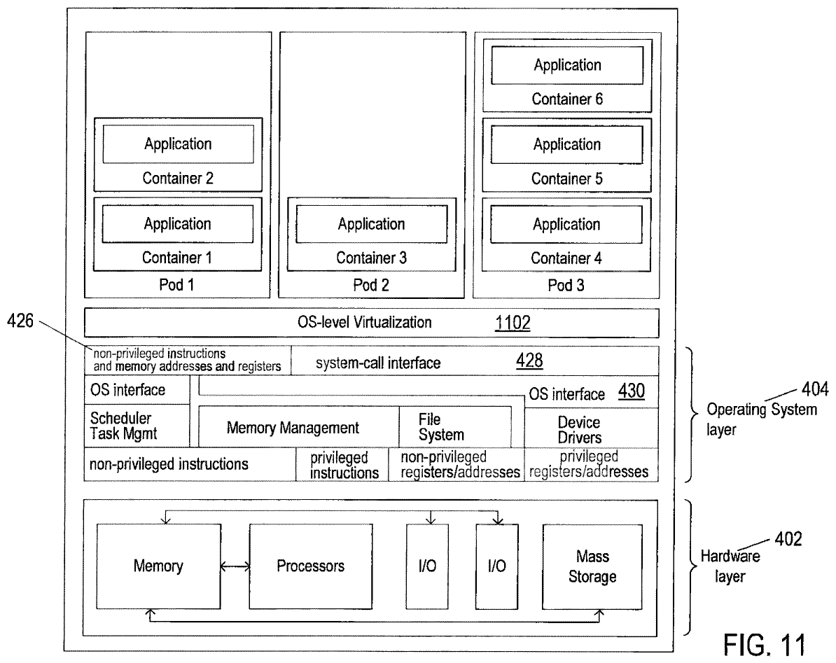

FIG. 11 shows an example server computer used to host three pods. As discussed above with reference to FIG. 4, an operating system layer 404 runs on the hardware layer 402 of the host computer. The operating system provides an interface, for higher-level computational entities, that includes a system-call interface 428 and the non-privileged instructions, memory addresses, and registers 426 provided by the hardware layer 402. However, unlike in FIG. 4, in which applications run directly on the operating system layer 404, OSL virtualization involves an OSL virtualization layer 1102 that provides operating-system interfaces to each of the pods 1-3. In this example, applications are run separately in containers 1-6 that are in turn run in pods identified as Pod 1, Pod 2, and Pod 3. Each pod runs one or more containers with shared storage and network resources, according to a specification for how to run the containers. For example. Pod 1 runs an application 1104 in container 1 and another application 1106 in a container identified as container 2.

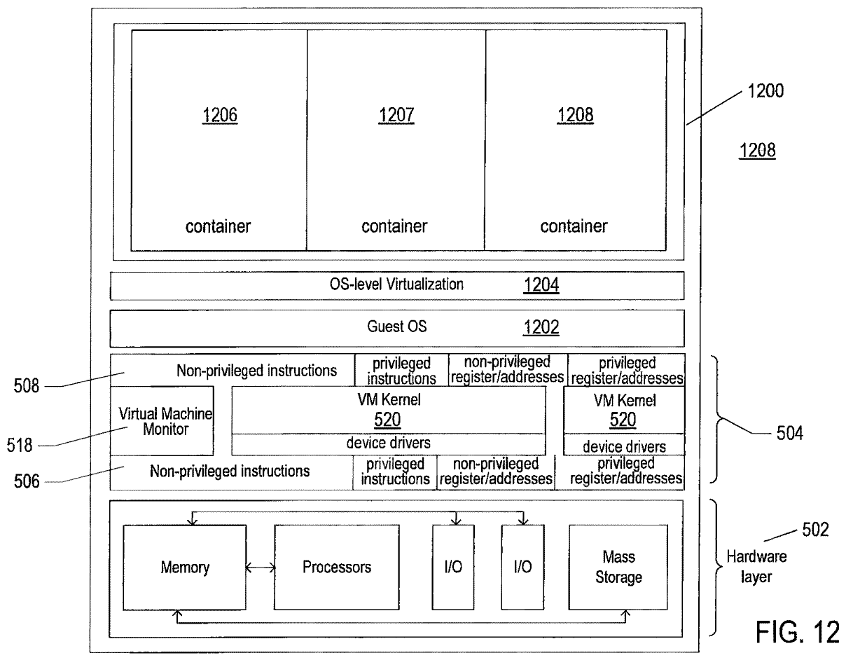

FIG. 12 shows an approach to implementing the containers in a VM. FIG. 12 shows a host computer similar to that shown in FIG. 5A, discussed above. The host computer includes a hardware layer 502 and a virtualization layer 504 that provides a virtual hardware interface 508 to a guest operating system 1202. Unlike in FIG. 5A, the guest operating system interfaces to an OSL-virtualization layer 1204 that provides container execution environments 1206-1208 to multiple application programs.

Note that, although only a single guest operating system and OSL virtualization layer are shown in FIG. 12, a single virtualized host system can run multiple different guest operating systems within multiple VMs, each of which supports one or more OSL-virtualization containers. A virtualized, distributed computing system that uses guest operating systems running within VMs to support OSL-virtualization layers to provide containers for running applications is referred to, in the following discussion, as a “hybrid virtualized distributed computing system.”

Running containers above a guest operating system within a VM provides advantages of traditional virtualization in addition to the advantages of OSL virtualization. Containers can be quickly booted in order to provide additional execution environments and associated resources for additional application instances. The resources available to the guest operating system are efficiently partitioned among the containers provided by the OSL-virtualization layer 1204 in FIG. 12, because there is almost no additional computational overhead associated with container-based partitioning of computational resources. However, many of the powerful and flexible features of the traditional virtualization technology can be applied to VMs in which containers run above guest operating systems, including live migration from one host to another, various types of high-availability and distributed resource scheduling, and other such features. Containers provide share-based allocation of computational resources to groups of applications with guaranteed isolation of applications in one container from applications in the remaining containers executing above a guest operating system. Moreover, resource allocation can be modified at run time between containers. The traditional virtualization layer provides for flexible and scaling over large numbers of hosts within large, distributed computing systems and a simple approach to operating-system upgrades and patches. Thus, the use of OSL virtualization above traditional virtualization in a hybrid virtualized distributed computing system, as shown in FIG. 12, provides many of the advantages of both a traditional virtualization layer and the advantages of OSL virtualization.

### Computer-Implemented Methods and Systems for Detecting and Correcting Trending Problems with Applications Using Language Processing

The virtualization technologies described herein have enabled software service providers to run their applications in data centers and offer software as a service (“SaaS”) to end users over the internet. SaaS is a licensing and software distribution model in which services of an application are licensed to end users. Licensed end users can access and utilize the service over the internet using any device with a network or internet connection. Software providers deploy their applications and related data storage in their own data center. Alternatively, software providers contract with cloud service providers to host their applications in the providers' data centers.

FIG. 13 shows an example of an application 1302 that provides SaaS over the internet 1304 to end uses via devices, such as a laptop 1306, a tablet 1307, a desktop computer 1308, a mobile phone 1309, and a desktop computer 1310 that accesses the internet 1304 via a private system of server computers 1312. Each end user pays for a separate license to access and utilize the services of the application 1302 over the internet 1304 via the devices 1306-1310. The services provided by the application 1302 can be office services, such as word processing and data organization, messaging, payroll processing, software development environment, entertainment streaming, or online gaming. In the example of FIG. 13, the application 1302 is deployed as a distributed application with application components run in virtual machines denoted by VMᵢ, where i=1, . . . , 14. The VMs are run in a virtualization layer 1314 that is illustrated above a physical data center 1316. For the sake of illustration, the virtualization layer 1314 is separated from the data center 1316 by a virtual-interface plane 1318. The data center 1316 is an example of a distributed computing system that comprises physical objects, including an administration computer system 1320, any of various computers, such as systems administration PC 1322, on which a virtual data center (“VDC”) management graphical user interface (“GUI”) is displayed to system administrators and other users, server computers, such as server computers 1324-1332, mass-storage arrays 1334-1336, and network devices, such as switches and routers (not shown). The server computers are networked together to form server-computer groups within the data center 1316. The example physical data center 1304 includes three server-computer groups each of which have eight server computers. For example, interconnected server computers 1312-1319 form a server group that is connected to a mass-storage array 1334. For the sake of illustration, the data center 1304 and virtualization layer 1302 are shown with a small number of objects. In practice, a typical data center runs thousands of server computers that are used to run thousands of VMs and containers. Different data centers may include many different types of computers, networks, data-storage systems, and devices connected according to many different types of connection topologies described below.

The virtual-interface plane 1318 abstracts the physical resources of the physical data center 1316 to virtual objects, such as VMs, applications, and containers, hosted by the server computers in the physical data center 1316. For example, the virtual-interface plane 1318 abstracts the physical resources of the server computers 1312-1319 to the VMs of the application 1302 and the mass-storage arrays 1334-1336 to virtual data stores 1338 and 1340. The virtualization layer 1302 may also include a virtual network (not illustrated) of virtual switches, routers, load balancers, and NICs.

The virtualization layer 1314 also includes an operations manager 1342 that runs on the administration computer system 1320. The operations manager 1342 receives attribute information from physical and virtual objects of the data center 1304. For example, the operating systems of PC 1322, server computers, and mass-storage arrays send metrics, such CPU usage, memory, disk storage, and key performance indicators, to the operations manager 1332. Virtual objects of the virtualization layer 1314, such as the VMs, containers, applications, and virtual data stores, independently send metrics to the operations manager 1342. The operations manager 1342 processes the metrics to detect and report performance problems with the physical and virtual objects of the data center in the GUI of the systems administration PC 1322. The operations manager 1342 can also be used to correct problems with hardware and virtual objects of the data center. For example, the operations manager 1342 can be to reissue SaaS licenses, migrate virtual objects, such as VMs or virtual data stores, to server computers and data storage devices that have more resources than the server computers and data storage devices the VMs and virtual data store are currently executing on.

The virtualization layer 1314 also includes a support manager 1344 that executes operations described below to timely identify and resolve trending problems of the application 1302. Trending problems are of particular importance to software service providers. Trending problems are an indication of a persistent problem that is typically experienced by many end users. Trending problems frustrate much larger numbers of end users than isolated issues, which can damage the reputation of the software service provider and cause end users to switch to similar services provided by another software service provider. As a result, software services providers cannot afford prolonged service disruptions caused by trending problems. Issues with performance of the application are reported to the support manager 1344 by end users as support requests (“SRs”). The support manager 1344 also receives and stores knowledge base (“KB”) articles that describe problems with the application and describe how the problem was resolved in the past.

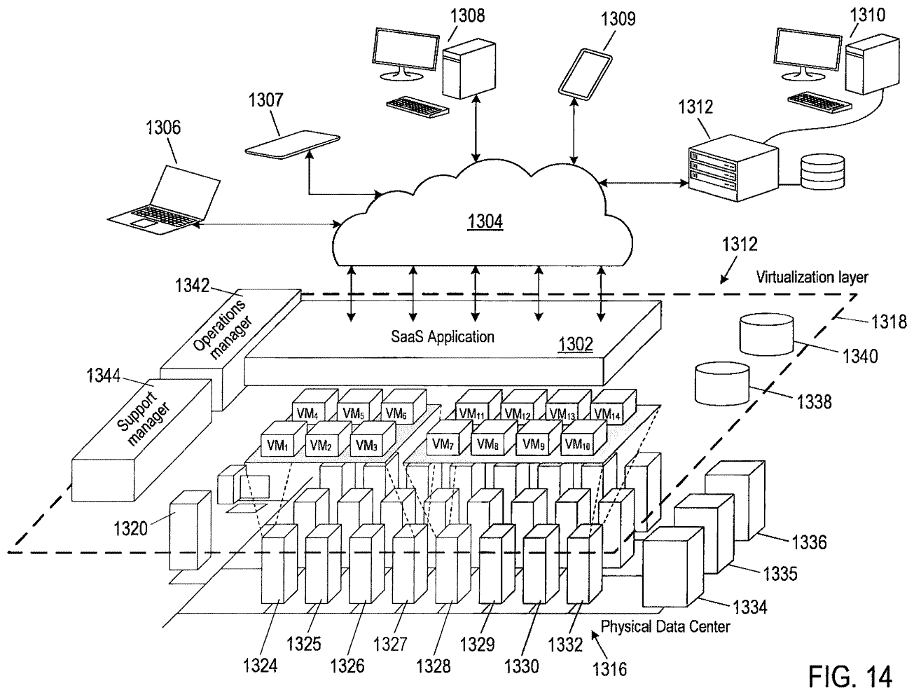

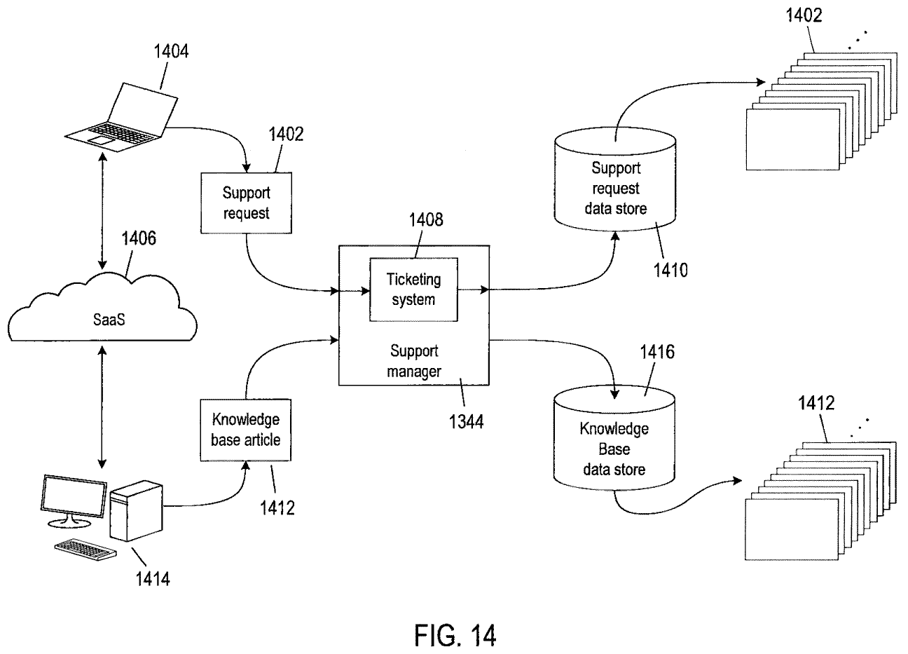

FIG. 14 shows an example of the support manager 1344 receiving and storing SRs and KB articles. In this example, the support manager 1344 receives an SR 1402 from a device 1404 that runs a service of a SaaS application 1406. The support manager 1344 runs a ticketing system 1408 that enables the end user of the device 1404 to submit the SR 1402 using natural language to describe the problem via a GUI. The ticketing system 1408 applies a unique ID to the SR and stores the SR as a document with a natural language description of the problem in a SR data store 1410.

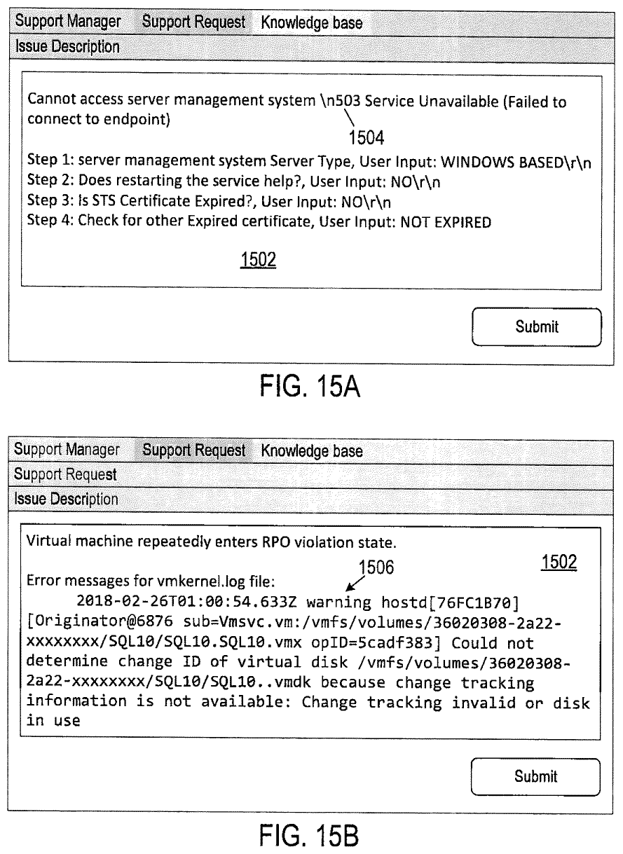

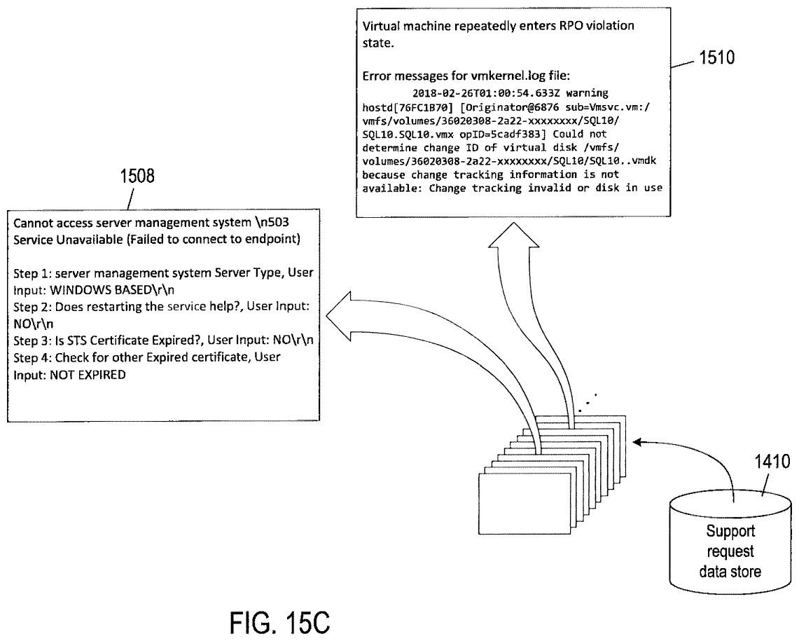

FIGS. 15A-15B show an example of a support manager GUI and two example SRs. The ticketing system GUI includes field 1502 that enables an end user to describe in natural language the problem. For example, in FIG. 15A, the end user describes a problem created by not being able to access a server management system. The end user has entered the HTTP status code 1504 and explains that the service is unavailable. In FIG. 15B, the user describes a problem created by a VM repeatedly entering a recover point object (“RPO”) violation state. The recovery point objective (“RPO”) is the age of files that must be recovered from backup storage for normal operations of the VM to resume after a hardware, program or network communications failure. Note that the end user has copied and pasted the error message 1506 from the vmkernel.log file. In FIGS. 15A-15B, when the end user clicks on the “submit” button, the ticketing system 1408 separately stores the SRs as documents with the natural language descriptions of the corresponding problems entered via the GUIs in the SR data store 1410. FIG. 15C shows the SR input via the GUI in FIG. 15A stored as document 1508 and the SR input via the GUI in FIG. 15B stored as document 1510.

Returning to FIG. 14, the support manager 1344 also receives KB articles written by systems administrators, application developers, or support team members of a software service provider. A KB article is a natural language description of a particular problem and how the problem was resolved. In FIG. 14, a systems administrator, an application developer, end user, or the software service provider has identified a problem with the SaaS 1406 and discovered a solution to the problem. The support manager provides a GUI that enables a person to describe the problem and resolution in a KB article 1412 on a device 1414 and store the KB article 1412 in a KB data store 1416.

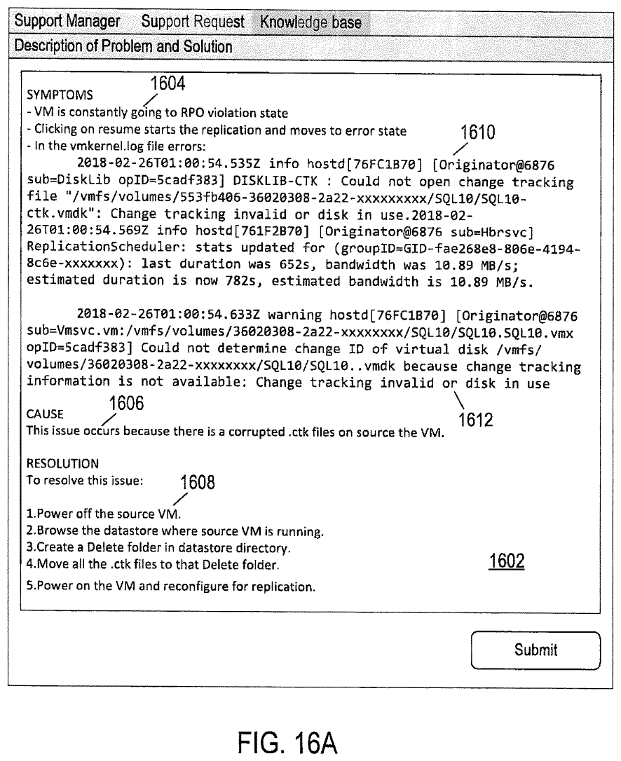

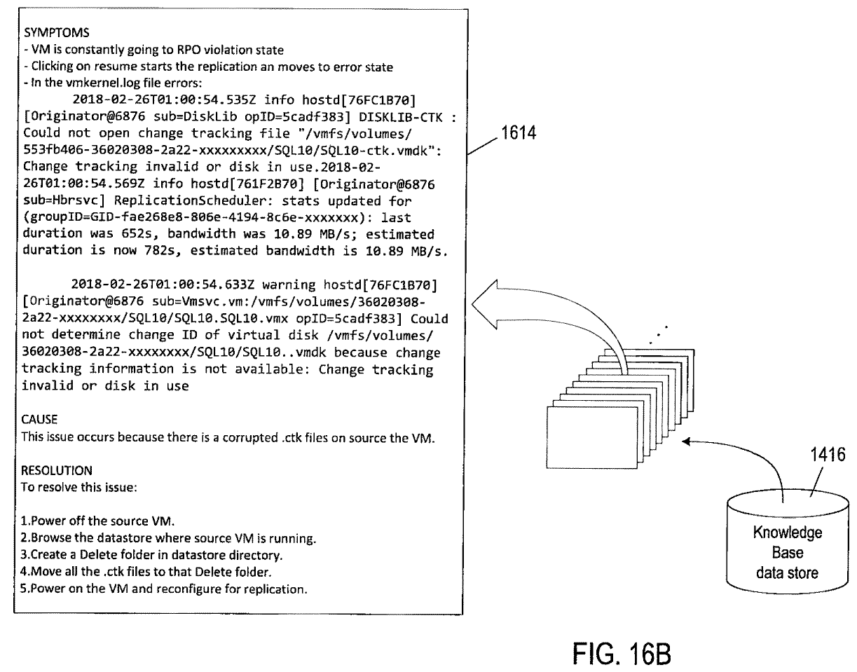

FIG. 16A shows an example of a support manager GUI with a field 1602 with a KB article. In this example, the KB article describes the systems 1604 of the problem, the cause 1606, and a description 1608 of how the author of the KB article resolved the issue. The author has also copied log messages 1610 and 1612 that describe symptoms of the problem. In FIG. 16A, when the end user clicks on the “submit” button, the support manager 1344 stores the KB article as a document with the natural language descriptions entered via the GUI in the KB data store 1416. FIG. 16B shows the KB article input via the GUI in FIG. 16A stored as document 1614.

Software service providers of a SaaS application have a support team that reads the SRs and separately resolves each problem. When a support team member resolves a problem described in an SR, the support team member closes the SR. However, because the problems are resolved separately and often resolved by different support team members, trending problem are typically overlooked because each problem of a trending problem is viewed as an isolated incident. In other words, support teams often miss trending problems. However, trending problems are typically a sign of a persistent problem experienced by many end users. To provide continuous proactive support for SaaS applications and avoid overlooking trending problems, the support manager 1344 automatically detects and isolates trending problems, thereby avoiding preventing the same problem from affecting large numbers of end users.

The support manager 1344 uses token embeddings of the stored SRs and KB as input to a pre-trained deep bidirectional encoder representations transformer and clustering techniques (“vsBERT”) to identify semantically similar SRs and KB articles. The semantically similar SRs and KB articles represent historically similar support problems and KB articles that describe remedial measures for correcting the problems, vsBERT is used to discover word associations between the SRs and KB articles with emerging groups of trending problems that evolve over time. The support manager 1344 incorporates the topic discovery of trending problems and builds a rule discovery system for the portfolio of proactive support capabilities by introducing productive and more prescribed techniques of analytics. The support manager 1344 also includes a framework for collecting user feedback on efficiency of discovering trending problems and recommending remedial measures for correcting the trending problems.

The support manager 1344 discovers semantically similar SRs and KB articles be first converting the SRs and KB articles into corresponding token embeddings that allows words of the SRs and KB articles with similar meaning to have a similar representation. The support manager 1344 uses regular expressions to discard unnecessary parameters, commonly used words, and nonessential mixed numerical and character strings of the natural language text of the SRs and KB articles, leaving only essential strings, called tokens, of the SRs and KB articles.

A regular expression, also called “regex,” is a sequence of symbols that defines a search pattern in text data. Many regex symbols match letters and numbers. For example, the regex symbol “a” matches the letter “a,” but not the letter “b,” and the regex symbol “100” matches the number “100.” but not the number 101. The regex symbol “.” matches any character. For example, the regex symbol “.art” matches the words “dart,” “cart,” and “tart,” but does not match the words “art,” “hurt,” and “dark.” A regex followed by an asterisk “*” matches zero or more occurrences of the regex. A regex followed by a plus sign “+” matches one or more occurrences of a one-character regex. A regular expression followed by a questions mark “?” matches zero or one occurrence of a one-character regex. For example, the regex “a*b” matches b, ab, and aaab but does not match “baa.” The regex “a+b” matches ab and aaab but does not match b or baa. Other regex symbols include a “\d” that matches a digit in 0123456789, a “\s” matches a white space, and a “\b” matches a word boundary. A string of characters enclosed by square brackets. [ ], matches any one character in that string. A minus sign “−” within square brackets indicates a range of consecutive ASCII characters. For example, the regex [aeiou] matches any vowel, the regex [a-f] matches a letter in the letters abcdef, the regex [0-9] matches a 0123456789, the regex [._%+−] matches any one of the characters ._%+−. The regex [0-9a-f] matches a number in 0123456789 and a single letter in abcdef. For example, [0-9a-f] matches a6, i5, and u2 but does not match ex, 9v, or %6. Regular expressions separated a vertical bar “|” represent an alternative to match the regex on either side of the bar. For example, the regular expression Get|GetValue|Set|SetValue matches any one of the words: Get, GetValue, Set, or SetValue. The braces “{ }” following square brackets may be used to match more than one character enclosed by the square brackets. For example, the regex [0-9]{2} matches two-digit numbers, such as 14 and 73 but not 043 and 4, and the regex [0-9](1-2) matches any number between 0 and 99, such as 3 and 58 but not 349.

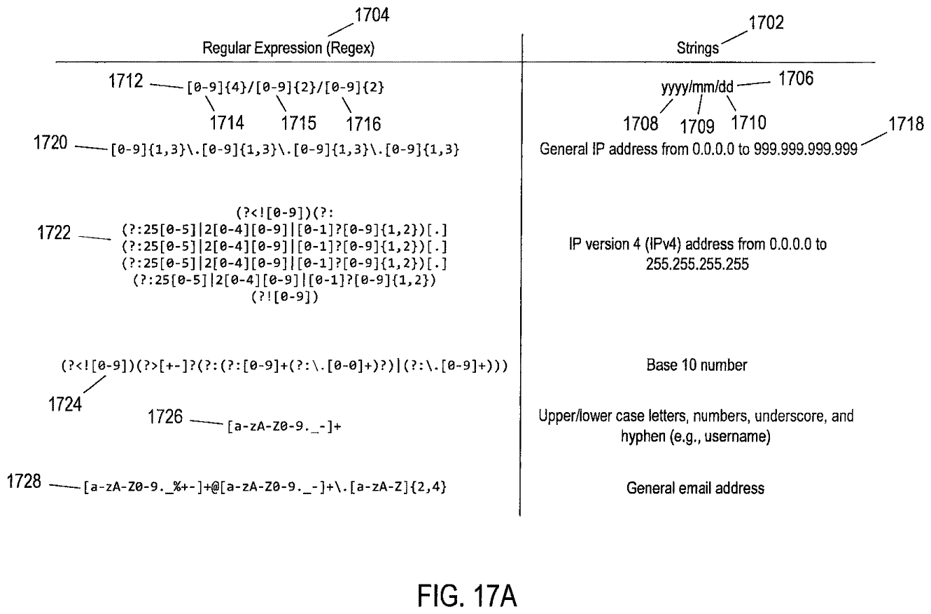

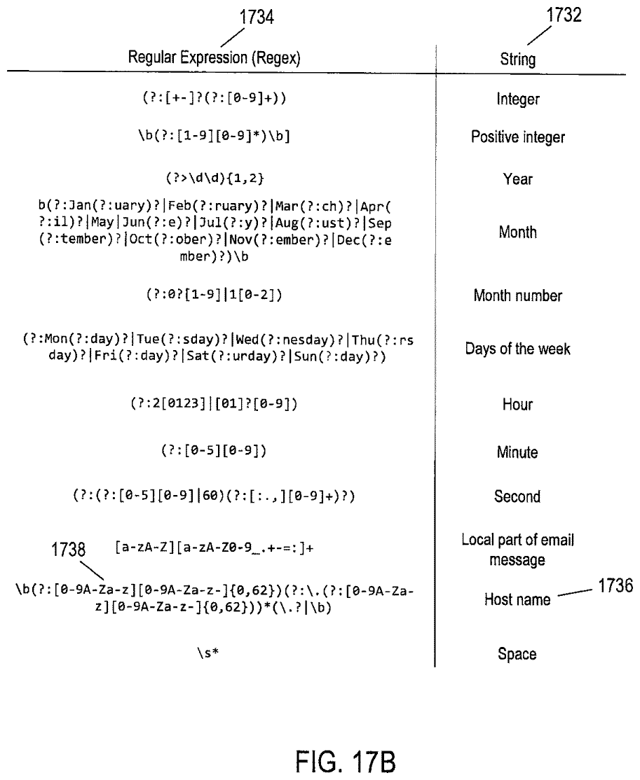

Simple regular expressions are combined to form larger regular expressions that match character strings of natural language text and can be used to extract the character strings from the SRs and KB articles. FIG. 17A shows a first table of examples of regular expressions designed to match particular character strings of SRs and KB articles. Column 1702 list six different types of strings that may be found in SRs and KB articles. Column 1704 lists six regular expressions that match the character strings listed in column 1702. For example, entry 1706 of column 1702 represents a format for a date used in the time stamp. The date is represented with a four-digit year 1708, a two-digit month 1709, and a two-digit day 1710 separated by slashes. The regex 1712 includes regular expressions 1714-1716 separated by slashes. The regular expressions 1714-1716 match the characters used to represent the year 1708, month 1709, and day 1710. Entry 1718 of column 1702 represents a general format for internet protocol (“IP”) addresses. A typical general IP address comprises four numbers. Each number ranges from 0 to 999 and each pair of numbers is separated by a period, such as 27.0.15.123. Regex 1720 in column 1704 matches a general IP address. The regex [0-9]{1-3} matches a number between 0 and 999. The backslash “\” before each period indicates the period is part of the IP address and is different from the regex symbol “.” used to represent any character. Regex 1722 matches any IPv4 address. Regex 1724 matches any base-10 number. Regex 1726 matches one or more occurrences of a lower-case letter, an upper-case letter, a number between 0 and 17, a period, an underscore, and a hyphen in a character string. Regex 1728 matches email addresses. Regex 1728 includes the regex 1726 after the ampersand symbol.

FIG. 17B a second table of examples of regular expressions designed to match particular character strings of SRs and KB articles. Column 1732 contains a list of strings. Column 1734 contains a list of regular expressions that can be used to extract the strings listed in column 1732. For example, a hostname comprises a sequence of labels that are concatenated with periods. A string that represents a host name 1736 of a server computer can be extracted from natural language text with the regex 1738. Note that the list of regular expressions shown in FIGS. 17A-17B is not an exhaustive list of regular expressions that can be used to extract text from SRs and KB articles.

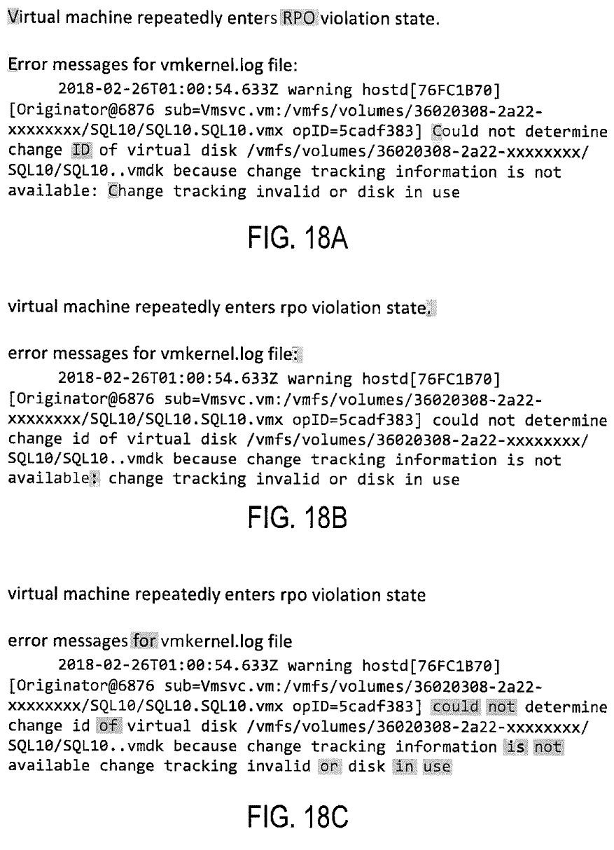

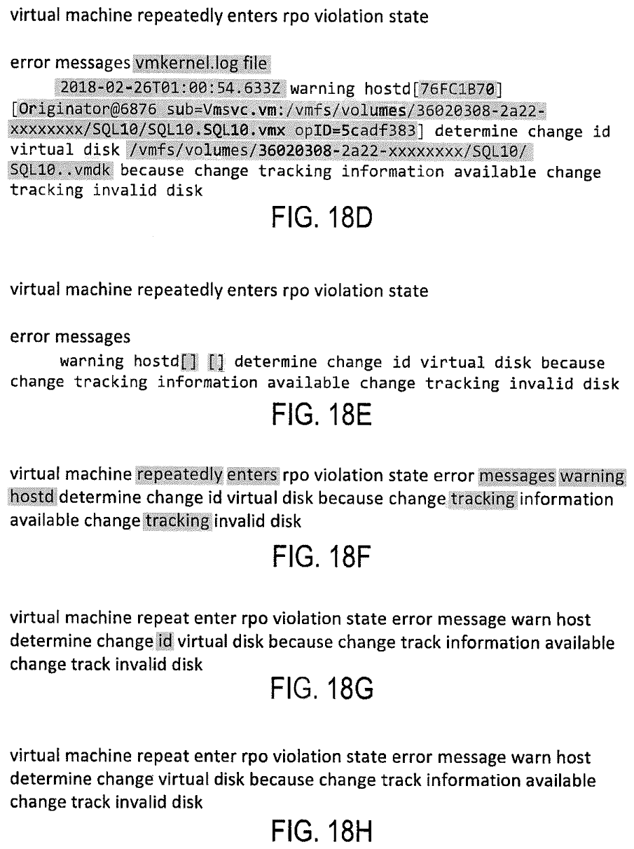

The support manager 1344 uses regexes to tokenize the SRs of the SR data store 1410 by reducing each SR to a corresponding set of tokens. The support manager 1344 also tokenizes the KB articles of the KB articles data store 1416 by reducing each KB article to corresponding a set of tokens. FIGS. 18A-18H show an example of the steps executed by the support manager to reduce the single SR 1510 described above with reference to FIGS. 15B and 15C to a set of tokens. The support manager 1344 repeats the operations represented by FIGS. 18A-18H for each SR in the SR data store 1410. The support manager 1344 uses a regex ([A-Z])(.*) to find uppercase letters in words and replace the uppercase with lowercase using the regex \L$1$2. In FIG. 18A, the uppercase letters are identified by shading and reduced to lowercase as shown in FIG. 188. The support manager 1344 uses regular expressions to find punction and delete the punctuation. In FIG. 18B, the punctuation is identified with shade and deleted as shown in FIG. 18C. The support manager 1344 removes stop words from the text. Stop words are commonly used words that provide no meaningful information. Examples of stop words are “a,” “an,” “the,” “and,” “it,” for”, and “in.” The support manager 1344 finds the stop words using regular expressions for the stop words and deletes the stop words from the text leaving behind the less common more meaningful words that can be used to identify similar SRs and KB articles. In FIG. 18C, the stop words are identified by shading and removed to obtain the text shown in FIG. 18D. The support manager 1344 uses regular expressions to remove links, time stamps, email address, host names, and urls from the text. For example, regular expressions for finding and removing links, time stamps, email address, host names, and urls can be constructed from the regular expressions listed in the tables of FIG. 17A-17B. In FIG. 18D, the links, time stamps, host names, and urls of the text are identified by shading and removed to obtain the remaining text shown in FIG. 18E. The support manager 1344 removes brackets shown in FIG. 18E with the expression \\[|\\] and merges the remaining text as shown in FIG. 18F. The support manager 1344 uses stemming and/or lemmatization to convert words to the base form of the word. For example, the base form of the word “repeatedly” is “repeat” and the base form of the word “enters” is “enter.” In FIG. 18F, shading is used to identify words that are shortened to the base form of the words using stemming and/or lemmatization as shown in FIG. 18G. The support manager 1344 may also find and remove words with fewer than three letters using the regular expression \W*\b\w{1,2} identified by shading in FIG. 18G. FIG. 18H shows the remaining set of tokens of the original SR 1510 of FIG. 15B.

After the support manager 1344 has tokenized each of the SRs in the SR data store 1410, the support manager 1344 counts the number of times, or frequency, of each token in the remaining set of tokens. The support manager 1344 forms a count vector for each SR in the support vector data store 1410 based on the total number of different tokens, N. of the SRs. Let J be the number of SRs in the SR data store 1410. The frequency of a token in a single SR is denoted by f_{n,j}, where subscript n is a token index and j is an SR index.

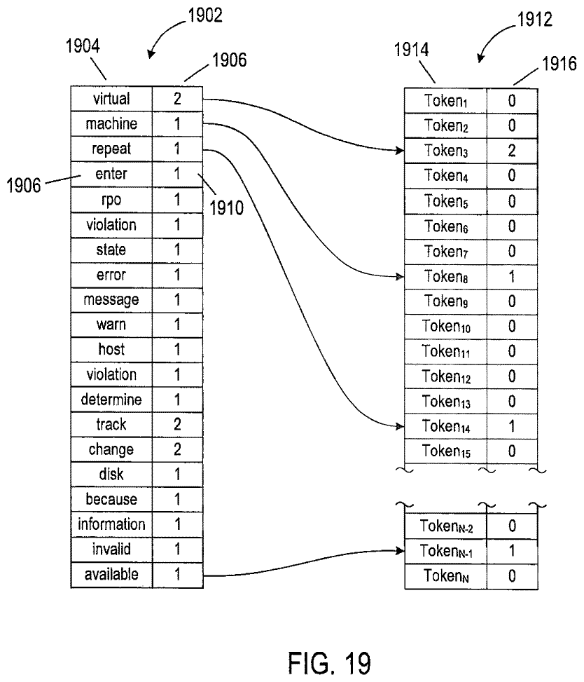

FIG. 19 shows an example of forming a count vector for the SR 1510 based on the set of tokens in FIG. 18H. Column 1904 of table 1902 contains a list of the different tokens in the set of tokens in FIG. 18H. Column 1906 contains the corresponding frequencies. For example, the token “enter” 1908 appears once in the set of tokens in FIG. 18H and has a frequency of “1” 1910. Table 1912 contains the values of count vector for the SR 1510 formed from the counts of the tokens in table 1902. Let N represent the number of different tokens of the SRs in the SR data store 1410. The N different tokens are represented in column 1914 by Tokenₙ, where index n=1, . . . , N. Each of the tokens in column 1904 corresponds to a token in column 1914. For example, the token “virtual” in column 1904 is represented by Token₃ in column 1914. Column 1916 contains the frequencies of the tokens for the SR 1510. Token₃ that are not in the set of tokens in FIG. 18H have zero frequency. For example, Token₁ represents a token that is contained in a different SR in the SR data store 1410 because the token did not appear in the set of tokens in FIG. 18H and the corresponding frequency is zero. Column 1916 represents an N-dimensional count vector of the SR 1510.

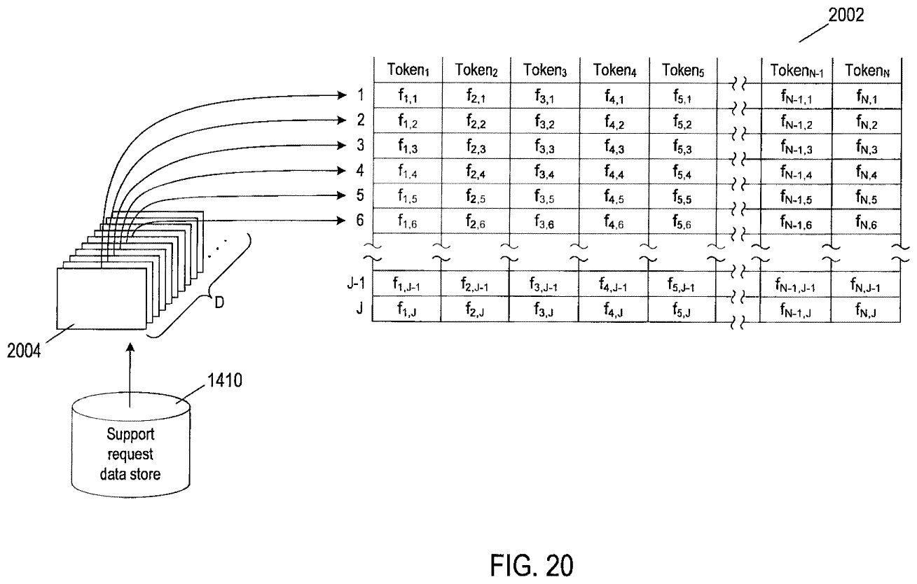

FIG. 20 shows a table 2002 of frequencies of tokens of each SR in the corpus of SRs stored in the SR data store 1410. The corpus of SDs is denoted by D. The corpus contains J SRs. The table 2002 contains J rows, each row contains the frequencies of the tokens associated with one of the J SRs. For example, frequencies of the tokens of the SR 2004 are represented by entries in row “1” of the table 2002.

The support manager 1344 computes an N-dimensional token embedding for each SR based on the frequencies of the tokens of the SR. Each element of a token embedding is a term frequency-inverse document frequency (“tf-idf”) of a corresponding token in the SR. The tf-idf value is a measure of the importance of tokens in the corresponding SRs. For example, the tf-idf value of a token increases in proportion to the frequency of a token in an SR (i.e., term frequency) and is offset by the number of SRs in the corpus D that contain the token (i.e., inverse document frequency). The term frequency of the n-th token in an SR is given by

$${tf}_{n , j} = \frac{{f}_{n , j}}{{\sum }_{{n}^{′} ∈ d} {f}_{{n}^{′} , d}} \qquad ( 1 )$$

where d is the set of tokens of the SR.
   The inverse document frequency is given by

$${idf}_{n , D} = log \frac{J}{\vert d ∈ D : {token}_{n} ∈ d \vert} \qquad ( 2 )$$

The tf-idf of the n-th token of the j-th SR is given by

$$tf - {idf}_{n , j , D} = {tf}_{n , j} \times {idf}_{n , D} \qquad ( 3 )$$

The tf-idfs of an SR is the token embedding of the SR. Each SR in the corpus has a corresponding token embedding composed of the tf-idfs of tokens.

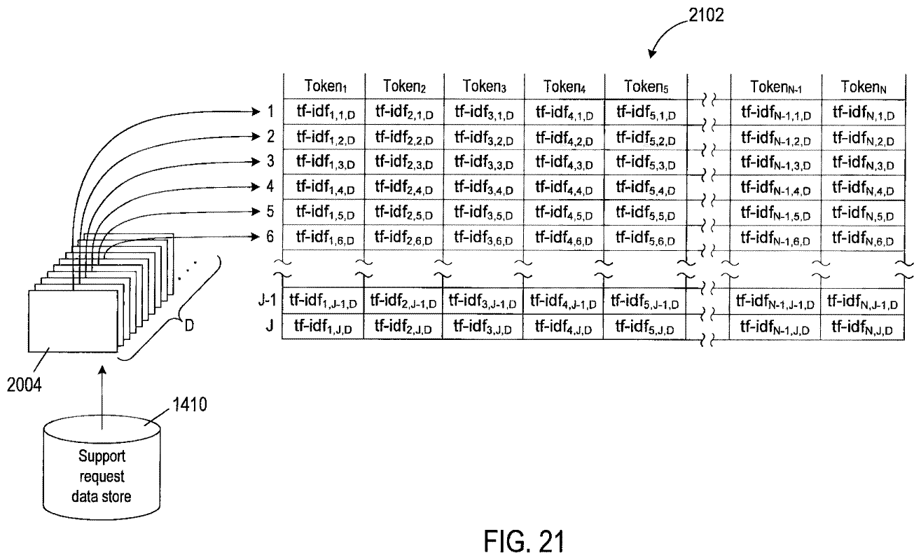

FIG. 21 shows a table 2102 of tf-idfs of the tokens of each SR in the corpus D stored in the SR data store 1410. The table 2102 contains J rows, each row contains the tf-idfs of the tokens associated with one of the J SRs. For example, the tf-idf entries of the tokens of the SR 2004 are represented by entries in row “1” of the table 2102. The collection of tf-idfs in each row of the table 2102 is a token embedding of an SR in the SR data store 1410. For example, the first row tf-idfs in row “1” is a token embedding of the SR 2004.

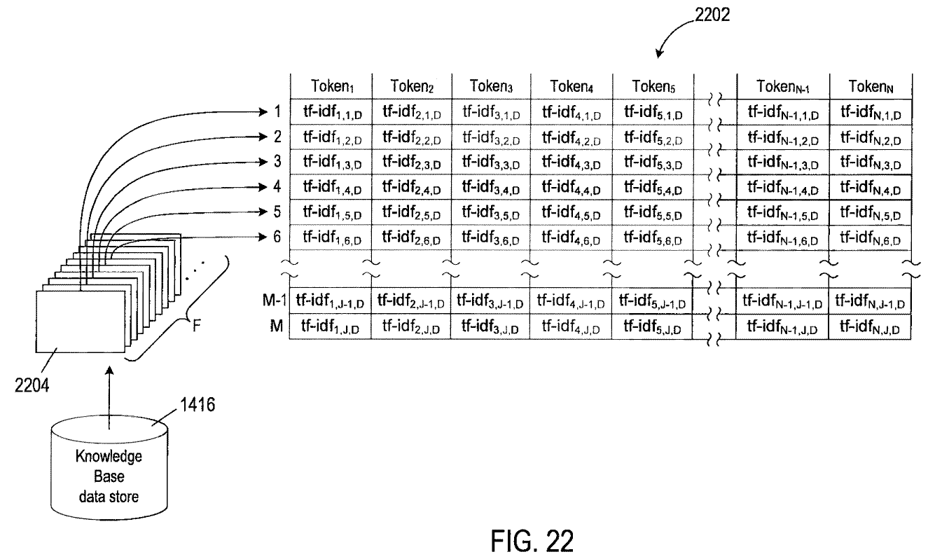

The process described above determines token embeddings for each of the SRs in the SR data store 1410. The same processing steps of tokenization, count vectorization, and token embedding described above with reference to FIGS. 18A-21 are repeated for the KB articles in the KB data store 1416 to obtain tf-idfs of the tokens of each KB article in the corpus of KB articles stored in the KB articles data store 1416 show in FIG. 22.

FIG. 22 shows a table 2202 of tf-idfs of the tokens of each KB article in the corpus F stored in the KB data store 1410. The table 2202 contains M rows, each row contains the tf-idfs of the N tokens associated with one of the M KB articles. For example, the tf-idf entries of the tokens of the KB article 2204 are represented by entries in row “1” of the table 2202. The collection of tf-idfs in each row of the table 2202 is a token embedding of a KB article in the KB data store 1416. For example, the first row of tf-idfs in row “I” is a token embedding of the KB article 2204.

The support manager 1344 computes a feature vector for each token embedding of the SRs in the corpus using a pre-trained fine-tuned model bidirectional encoder representation from transformers (“vsBERT”). The model vsBERT architecture is a multi-layer neural network that operates as a bidirectional transformer encoder. The weights of the vsBERT model can be pre-trained and fine-tuned using unsupervised tasks. For example, a certain percentage of input token embeddings (e.g., 15%) in each of the token embeddings are masked and the vsBERT model is trained to predict the masked token embeddings. The vsBERT model has been trained to receive as input each of the N token embeddings of the SRs and output corresponding L-dimensional feature vectors. For example, the dimensions, or length, of the feature vectors can be L=512 or L=1024. Each feature vector is stored in a SR feature vectors data store.

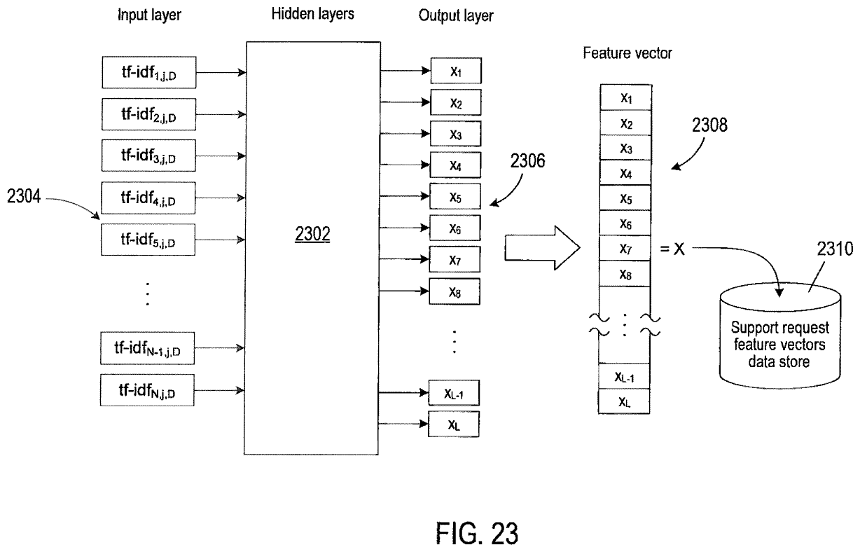

FIG. 23 shows an example of using vsBERT to compute a feature vector from N token embeddings of an SR. Block 2302 represents the hidden layers of the pre-trained vsBERT model. The N token embedding of the j-th SR are displayed as the input layer 2304 to the vsBERT model 2302. The L elements in the output layer 2306 of the vsBERT model are the elements of an L-dimensional feature vector 2308 denoted by X. The J SR feature vectors of the J SRs are stored in a support request feature vectors data store 2310.

The vsBERT model is also used to compute M L-dimensional feature vectors for the token embeddings of the KB articles. The vsBERT model receives as input each of the N token embeddings of a KB article and outputs a corresponding feature vector denoted by Y. Each KB feature vector is stored in a KB feature vectors data store.

The SR feature vectors and the KB feature vectors correspond to points in an L-dimensional space. Cosine similarity is used to measure the degree of similarity between two feature vectors in the L-dimensional space. Cosine similarity is computed as the cosine of the angle between two feature vectors and determines whether two feature vectors are pointing in roughly the same direction in the L-dimensional space. The cosine similarity between two feature vectors is given by

$$S ( {Z}_{p} , {Z}_{q} ) = cos ( {θ}_{pq} ) = \frac{{\sum }_{l = 1}^{L} {z}_{l , p} \cdot {z}_{l , q}}{\sqrt{{\sum }_{l = 1}^{L} {z}_{l , p}^{2} \cdot {\sum }_{l = 1}^{L} {z}_{l , q}^{2}}} \qquad ( 4 )$$

where
   Zₚ and Z_{q} represent feature vectors in the L-dimensional feature vector space; and
   θ_{pq} represents the angle between the feature vectors Zₚ and Z_{q} in the L-dimensional feature vector space.
      The feature vectors Zₚ and Z_{q} can represent two SR feature vectors, two KB feature vectors, or an SR feature vector and a KB feature vector. The cosine similarity ranges between 0 and 1. The smaller the value of the cosine similarity, the smaller the angle between the two feature vectors in the L-dimensional space. In other words, the SRs, KB articles, or SR and KB article with two corresponding feature vectors that have a small angle of separation are more similar than SRs, KB articles, or SR and KB article with two corresponding feature vectors that have a larger angle of separation. Two SRs, KB articles, or SR and KB article are identified as “similar” when the cosine similarity of the corresponding features vectors satisfies the following similarity condition:

$$S ( {Z}_{p} , {Z}_{q} ) < {Th}_{sim} \qquad ( 5 )$$

where Thₛᵢₘ is a user-defined similarity threshold (e.g., Thₛᵢₘ can be set equal to 0.2, 0.25, or 0.3). Two feature vectors that satisfy the condition in Equation (5) means the corresponding SRs are similar, KB articles are similar, or SR and KB article are similar. The support manager 1344 determines similar SRs in the SR data store 1410, similar KB articles in the KB data store 1416, and SRs and KB articles that are similar to one another and stores these similarities in a SR-KB predication data store.

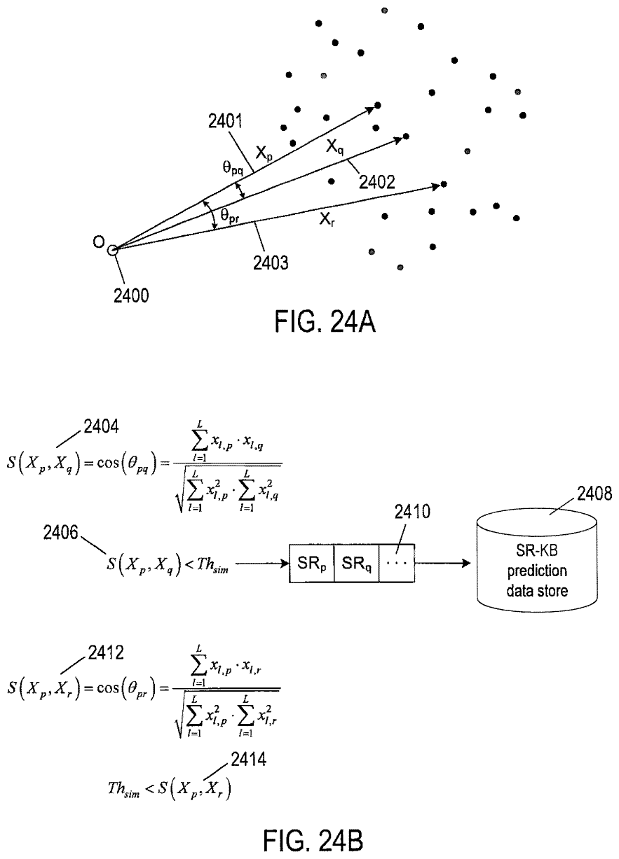

FIGS. 24A-24B show an example of using cosine similarity to determine similar SRs. In FIG. 24A, open circle 2400 represents the origin of the L-dimensional space. Solid dots represent coordinates of SR feature vectors. Three rays 2401-2403 that terminate at the points Xₚ, X_{q}, and Xᵣ represent three SR feature vectors in the L-dimensional space. Note that because the feature vectors originate from the origin 2400, the feature vectors are represented by the points Xₚ, X_{q}, and Xᵣ. The SR feature vectors 2401-2403 correspond to three SRs SRₚ, SR_{q}, and SRᵣ in the SR data store 1410. In FIG. 24B, the support manager 1344 computes a cosine similarity 2404 between the feature vectors 2401 and 2402. In this example, the cosine similarity 2404 satisfies the similarity condition 2406. As a result, the support requests SRₚ and SR_{q} are identified as similar and stored in a SR-KB database of the SR-KB predication data store 2408. Ellipsis represents other SRs that are identified as cosine similar to the support request SRₚ. As shown in FIG. 24B, the support manager 1344 also computes a cosine similarity 2412 between the feature vectors 2401 and 2403. In this example, the cosine similarity 2404 does not satisfy the similarity condition 2414. As a result, the support requests SRₚ and SRᵣ are not record as similar in the SR-KB database of the SR-KB predication data store 2408.

The support manager 1344 uses cosine similarity and similarity condition to determine similar KB articles. The KB articles with feature vectors that satisfy the similarity condition are recorded in the SR-KB database of the SR-KB predication data store 2408. For each SR in the SR data store, the support manager 1344 uses cosine similarity and similarity condition to determine KB articles that are similar to the SRs.

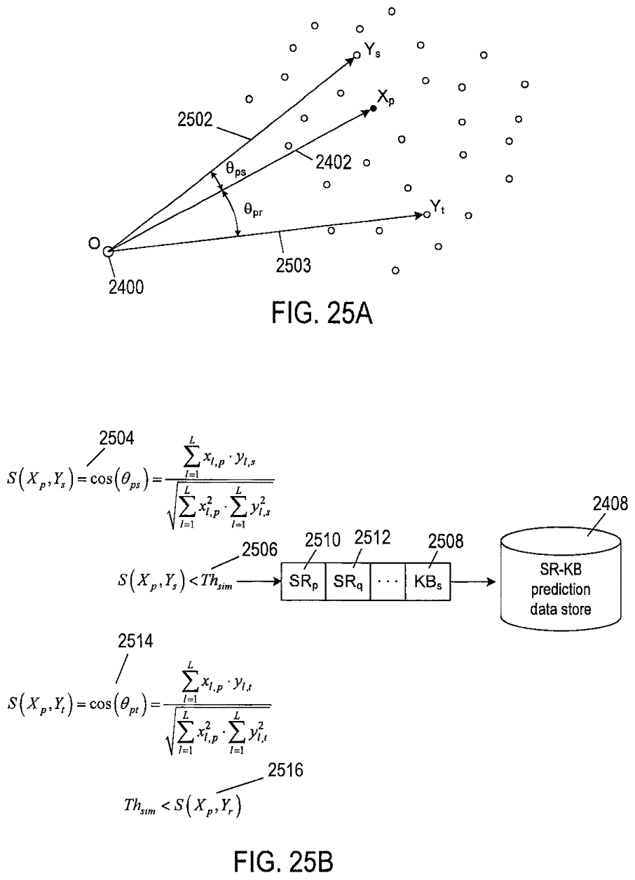

FIGS. 25A-25B show an example of using cosine similarity to determine KB articles that are similar to the SR, in FIG. 25A. Open dots represent coordinates of KB feature vectors that correspond to KB articles recorded in the KB data store 1416. In FIG. 25A, feature vector 2402 of the support request SR, is displayed. The rays 2502 and 2504 that terminate at the points Yₛ and Yₜ represent two KB feature vectors in the L-dimensional space. Note that because the feature vectors 2502 and 2503 originate from the origin 2400, the feature vectors are represented by the points Yₛ and Yₜ. In FIG. 25B, the support manager 1344 computes a cosine similarity 2504 between the feature vectors 2502 and 2503. In this example, the cosine similarity 2504 satisfies the similarity condition 2506. As a result, the KB article KBₛ 2508 is identified as similar to the support request SRₚ 2510 and other similar SRs 2512 and stored in the SR-KB database of the SR-KB predication data store 2408. As shown in FIG. 25B, the support manager 1344 also computes a cosine similarity 2514 between the feature vectors 2402 and 2503. In this example, the cosine similarity 2514 does not satisfy the similarity condition 2516. As a result, the KB article KBₜ is not record as similar in the SR-KB database of the SR-KB predication data store 2408.

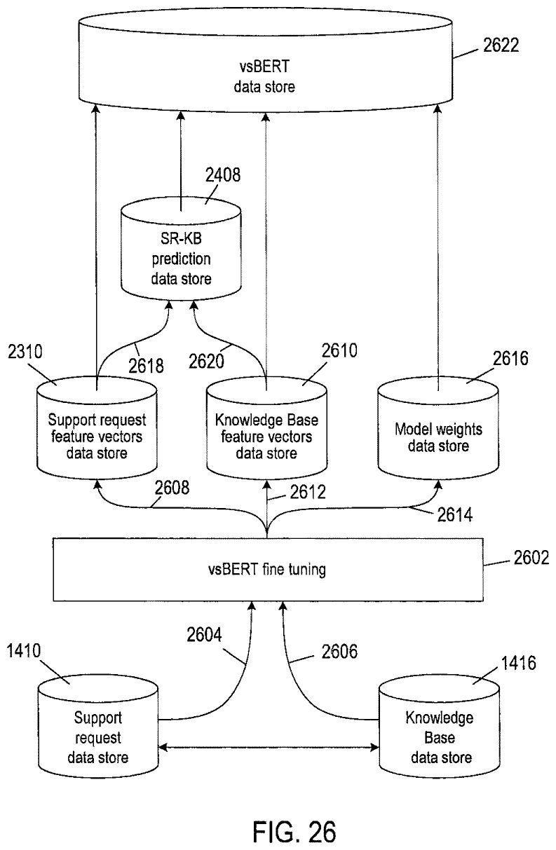

FIG. 26 shows updating SR feature vectors data store, KB feature vectors data store, model weights data store of BERT, and the database of SR-KB similarity predictions in response to receiving new SRs and new KB articles. Block 2602 represents the process of fine tuning vsBERT after new SRs are added to the SR data store 1410 as described above with reference to FIGS. 15A, 15B and new KB articles are added to the KB data store 1416 as described above with reference to FIG. 16A. Directional arrows 2604 and 2606 represent inputting new SRs and new KB articles to fine tune vsBERT in block 2602. Fine tuning vsBERT with new SRs produces new corresponding SR feature vectors that are added to the SR feature vector data store 2310 as indicated by directional arrow 2608. Fine tuning vsBERT with new KB articles produces new corresponding KB feature vectors that are added to the KB feature vector data store 2310 as indicated by directional arrow 2612. Fine tuning vsBERT in block 2602 adjusts the weights of the neural network of the vsBERT model. Directional arrow 2614 represents updating weights the model weights in the model weights data store 2616 of vsBERT. Cosine similarity described above is used to identify the newly added SR feature vectors and newly added KB features that satisfy the similarity condition and are added to the SR-KB prediction data store 2408 as represented by directional arrows 2618 and 2620. The updated SR feature vector data store 2310, KB feature vectors data store 2610, model weights data store 2616, and the SR-KB prediction data store 2408 combined form the vsBERT data store 2622.

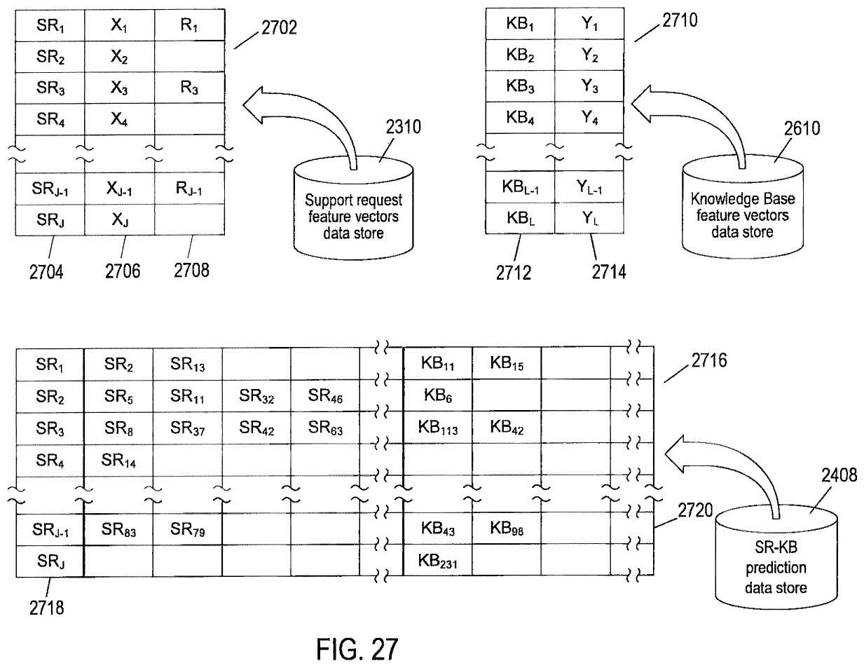

FIG. 27 shows the information stored in the SR feature vectors data store 2310, KB feature vector data store 2610, and the SR-KB prediction data store 2408. Table 2702 displays the types of data stored in the SR feature vectors data store 2310. Column 2704 contains a list SR IDs denoted by SRⱼ, where j=1, . . . , J. Column 2706 contains the corresponding SR feature vectors obtained using vsBERT described above. Column 2708 contains recommended remedial measures associated with certain SRs. Table 2710 displays the types of data stored in the KB feature vectors data store 2610. Column 2712 contains a list of KB IDs denoted by KBⱼ, where l=1, . . . , L. Column 2714 contains the corresponding KB feature vectors obtained using vsBERT described above. Table 2716 displays the types of data stored in the SR-KB prediction data store 2408. Column 2718 contains the list of SR IDs denoted by SRⱼ, where j=1, . . . , J. Rows contain the SR IDs of SRs and/or the KB IDs of KBs that are similar to the SRs listed in column 2718. For example, in row 2720. SR₈₃, SR₇₉, KB₄₃, and KB₉₈ are similar to the SRₗ₋₁.

The support manager 1344 identifies trending problems in recently created SRs over a recent time window. The support manager 1344 uses vsBERT to determine the feature vectors for SRs that have been created by end users in the recent time window. The support manager 1344 uses a clustering technique to detect clusters of features vectors in the recent time window. When a cluster of feature vectors with a cardinality greater than a trend threshold. Th_{trend}, is identified, the corresponding SRs are regarded as a trending problem. The support manager 1344 uses the SR-KB prediction data store 2408 to identify a closest similar SR with corresponding remedial measures and/or a closest similar KB articles to the newest of the trending SRs and displays the recommended remedial measures of the similar SR or the similar KB article in the management GUI.

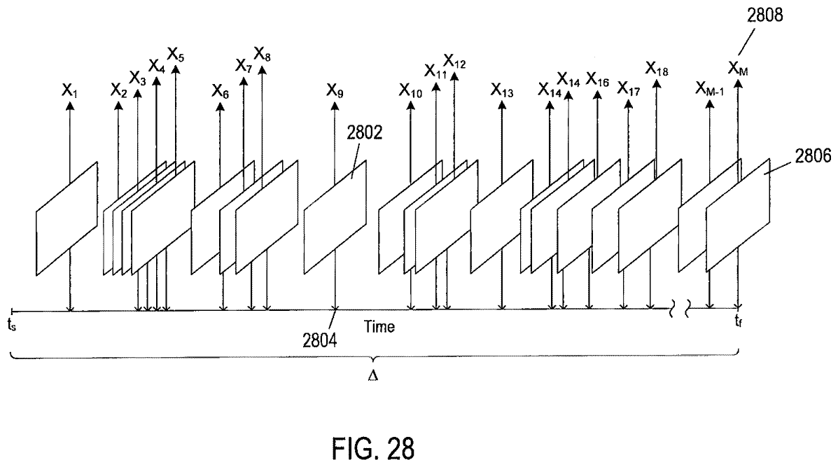

FIG. 28 shows an example of a recent time window with a start time denoted by tₛ, an end time denoted by t_{f}, and a duration Δ. Rectangles represent SRs created at different times in the recent time window. For example, rectangle 2802 is an SR created and input by an end user to the support manager 1344 at a time 2804 using the GUI as described above with reference to FIGS. 15A-15B. As each newly created SR is received, the support manager 1344 moves the recent time window so that the end time t_{f} corresponds to the time when the most recent SR is received and computes a corresponding feature vector as described above with reference to FIGS. 18A-23. For example, support request 2806 represents the most recent, or newest. SR created by an end user and is input to the support manager 1344. In response, the support manager 1344 computes a corresponding feature vector X_{M} 2808. As shown in FIG. 28, the recent time window contains M feature vectors that correspond to the M SRs with creation times in the recent time window. The support manager 1344 uses a cluster technique to detect any one or more clusters of feature vectors. When a cluster of feature vectors with a cardinality greater than a trend threshold, Th_{trend}, is identified, the corresponding SRs are regarded as a trending problem.

In one implementation. K-means clustering is used to detect a cluster of feature vectors. The value K corresponds to the number of clusters and, for example, may be set to a value greater than three. Let {Xₘ}ₘ₌₁^{M} denote a set of M feature vectors for M corresponding SRs created by end users in the recent time window. K-means clustering is an iterative process of partitioning the feature vectors into K clusters such that each feature belongs to one cluster with the closest cluster center. K-means clustering begins with the full M feature vectors and K cluster centers denoted by {Aᵣ}ᵣ₌₁^{K}, where Aᵣ is an L-dimensional cluster center. Each feature vector is assigned to one of the K clusters defined by:

$${C}_{k}^{( h )} = \{ {X}_{m} : S ( {X}_{m} , {A}_{k}^{( h )} ) \leq S ( {X}_{m} , {A}_{r}^{( h )} ) ∀ m , 1 \leq r \leq K \} where \qquad ( 6 )$$

$${C}_{k}^{( h )} is the k - th cluster k = 1 , 2 , … , K ; and$$

superscript h is an iteration index h=1, 2, 3, . . . .
   The cluster center Aₖ^{(h)} is the mean location of the feature vectors in the k-th cluster. A next cluster center is computed at each iteration by:

$${A}_{k}^{( h + 1 )} = \frac{1}{\vert {C}_{k}^{( h )} \vert} {\sum }_{{X}_{m} ∈ {C}_{k}^{( h )}} {X}_{m} \qquad ( 7 )$$

where |Cₖ^{(h)}| is the number of feature vectors in the k-th cluster (i.e., cardinality of the cluster).
   For each iteration h, Equation (6) is used to determine the cluster Cₖ^{(h)} each feature vector belongs to followed by recomputing the coordinate location of each cluster center according to Equation (7). The computational operations represented by Equations (6) and (7) are repeated for each iteration, h, until the feature vectors in each of the K clusters do not change. The resulting clusters of are represented by:

$${C}_{k} = {\{ {X}_{p} \}}_{p = 1}^{\vert {C}_{k} \vert} \qquad ( 8 )$$

where |Cₖ| is the number of feature vectors in the cluster Cₖ (i.e., cardinality of the cluster Cₖ).
   Each cardinality of each cluster is compared to the trend threshold, Th_{trend}. When a cardinality of a cluster satisfies the following condition:

$$\vert {C}_{k} \vert > {Th}_{trend} \qquad ( 9 )$$

the SRs that correspond to the feature vectors are identified as trending.

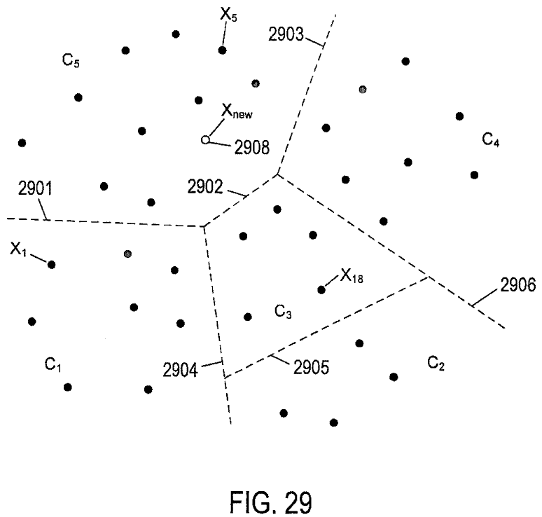

FIG. 29 shows an example plot of five clusters of L-dimensional feature vectors denoted by C₁, C₂, C₃, C₄, and C₅. Although each point represents an L-dimensional feature vector in L-dimensional space, for the sake of simplicity, the feature vectors are represented by points in two dimensions. Dashed lines 2901-2906 are used to separate five clusters. Suppose the trend threshold is set to ten (i.e., Th_{trend}=10). Open circle 2908 represents the feature vector of newly added SR to the recent time window. The feature vector has been identified as belonging to the cluster C₅. In this example, the number of feature vectors in the cluster C₅ is greater than the trend threshold. As a result, SRs that correspond to the feature vectors in the cluster C₅ are similar and show a trending problem.

In another implementation, density-based clustering is used to detect a cluster of feature vectors in the recent time window. Density-based clustering performs clustering based on neighborhoods of the feature vectors. The neighborhood of a feature vector Xₘ is defined by

$${N}_{ϵ} ( {X}_{m} ) = \{ {X}_{i} ∈ C \vert S ( {X}_{m} , {X}_{i} ) \leq ϵ \} \qquad ( 10 )$$

The number of feature vectors in a neighborhood of a feature is given by |N_{ϵ}(Xₘ)|, |⋅| denotes cardinality of a set.

A feature vector is identified as a core feature vector of a cluster of feature vectors, an edge feature vector of a cluster of feature vectors, or a noise feature vector based on the number of feature vectors that lie within the neighborhood of the feature vector. Let MinPts represent a user selected minimum number of feature vectors for a core feature vector. A feature vector Xₘ is core feature vector of a cluster of feature vectors when |N_{ϵ}(Xₘ)|≥MinPts. A feature vector Xₘ is a border feature vector of a cluster of feature vectors when MinPts>|N_{ϵ}(Xₘ)|>1 and contain at least one core feature vector in addition to the feature vector Xₘ. A feature vector Xₘ is noise when |N_{ϵ}(Xₘ)|=1 (i.e., when the neighborhood contains only the feature vector Xₘ).

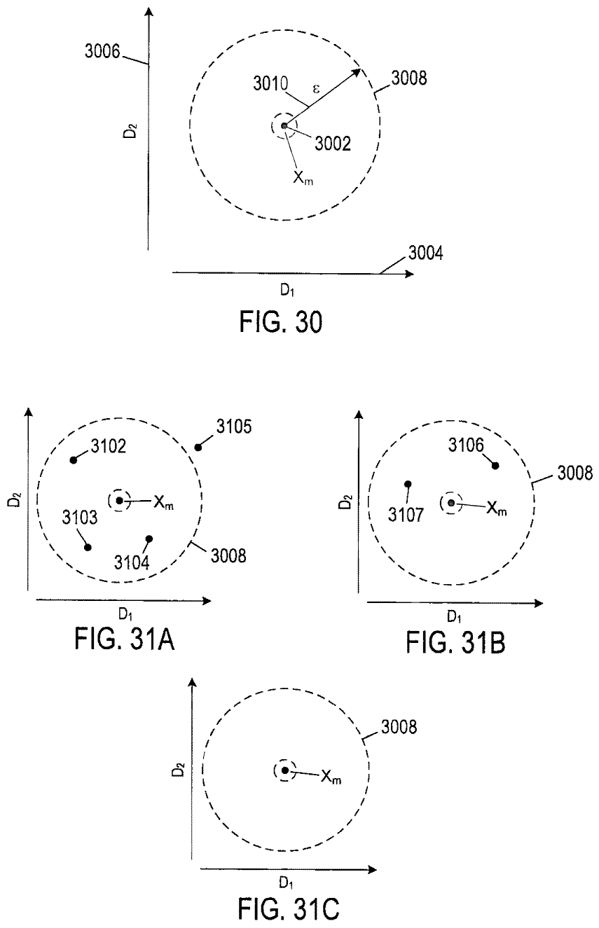

FIG. 30 shows an example of a neighborhood of the feature vector Xₘ denoted by the point 3002. Horizontal axis 3004 and vertical axis 3006 represent axes two dimensions in an L-dimensional space. The L-dimensional neighborhood of the feature vector, N_{ϵ}(Xₘ), is L-dimensional hyper-sphere with boundaries represented in two-dimensions by a dashed circle 3008 of radius 3010 centered on the feature vector Xₘ 3002. A feature vector Xᵢ is an element of the neighborhood N_{ϵ}(Xₘ) if S(Xₘ, Xᵢ)≤ϵ.

FIGS. 31A-31C show examples of the feature vector Xₘ as a core feature vector, a border feature vector, and noise, respectively. In this example, the minimum number of feature vectors for a core feature vector is set to 3 (i.e., MinPts=3). In FIG. 31A, points 3102-3105 represent feature vectors that are near the feature vector X, in the L-dimensional space. The feature vector Xₘ is a core feature vector because the three feature vectors 3102-3104 lie within the neighborhood 3008. As a result, the neighborhood 3008 contains 3 feature vectors, which is equal to MinPts. In FIG. 31B, the feature vector Xₘ is a border feature vector because the neighborhood 3008 contains the two feature vectors 3106 and 3107. In FIG. 31C, the feature vector Xₘ is noise because the neighborhood 3008 contains only the single feature vector Xₘ.

An feature vector Xₘ is directly density-reachable from another feature vector Xᵢ if 1) Xᵢ∈N_{ϵ}(Xₘ) and Xₘ is a core feature vector (i.e., |N_{ϵ}(Xₘ)|≥MinPts. In FIG. 31A, the feature vector 3102 is directly density-reachable from the feature vector Xₘ because the feature vector 3102 lies within the neighborhood 3008 and the neighborhood contains three feature vectors.

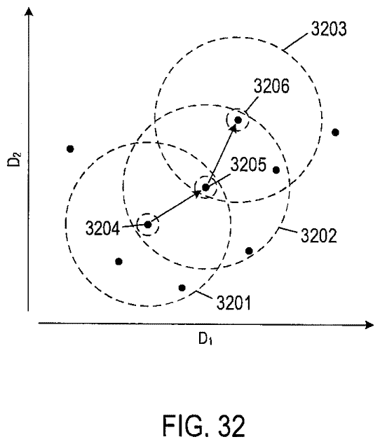

A feature vector Xᵢ is density reachable from an feature vector Xⱼ if there is a chain of feature vectors X₁, . . . , Xₙ, such that Xₖ₊₁, is directly density-reachable from Xₖ for k=1, . . . , n. FIG. 32 shows an example of a density reachable feature vector. Neighborhoods 3201-3203 are centered at feature vectors 3204-3206, respectively. Feature vector 3206 is density reachable from the feature vector 3204 because there is an intermediate feature vector 3205 that is directly density-reachable from the feature vector 3204 and the feature vector 3206 is directly density-reachable from the feature vector 3205.

Given MinPts and the radius e, a cluster of feature vectors can be discovered by first arbitrarily selecting a core feature vector as a seed and retrieving all feature vectors that are density reachable from the seed obtaining the cluster containing the seed. In other words, consider an arbitrarily selected core feature vector. Then the set of feature vectors that are density reachable from the core feature vector is a cluster of feature vectors. The cluster of feature vectors corresponds to a trend in similar SRs.

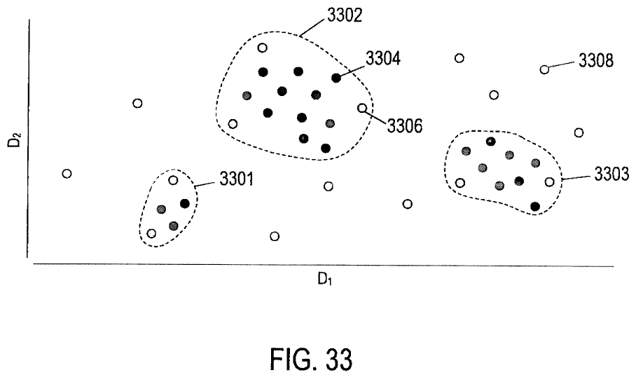

The support manager 1344 identifies clusters of feature vectors in a recent time window based on the minimum number of points MinPts and the radius E. FIG. 33 shows an example plot of three clusters of L-dimensional feature vectors 3301-3303. Each cluster contains core feature vectors identified by solid dots, such as solid dot 3304, and border feature vectors identified by gray shaded dots, such as gray shaded dot 3306. Open dots, such as open dot 3308, represent feature vectors identified as noise. In this example, the cardinality of the clusters 3301 and 3302 is less than the trend threshold (i.e., Th_{trend}=10) and the cardinality of the cluster 3302 is greater than the trend threshold. As a result, SRs that correspond to the feature vectors in the cluster 3302 are similar and show a trend in the recent time window.

When a trend is discovered for a new SR in a recent time window using K-means clustering or density-based cluster described above, the support manager 1344 computes the cosine similarity between the feature vector of the new SR and the SRs in the SR-KB prediction data store to identify the SR in the SR-KB prediction data store with the closest similarity to the new SR. If the SR with the closest similarity has a corresponding recommended remedial measure in the SR-KB prediction data store, the support manager 1344 retrieves the recommended remedial measures and displays the recommended remedial measures in the GUI of the support manager 1344. If the SR with the closest similarity does not have a corresponding recommended remedial measure in the SR feature vectors data store or in the SR-KB prediction data store, the support manager 1344 computes the cosine similarity between the feature vector of the new SR and the KBs in the SR-KB prediction data store to identify the KB article with the closest similarity. The support manager 1344 retrieves the KB article and displays the KB article in the GUI of the support manager 1344.

There are some other cases for which trendy SRs have neither related KB articles nor recommended remedial measures of other similar SRs. The support manager 1344 sends an alert to members of the application support team, displays an alert and message indicating that no recommended remedial measures have been recorded and ask for someone to identify a KB article or provide a KB article with recommended remedial measures.

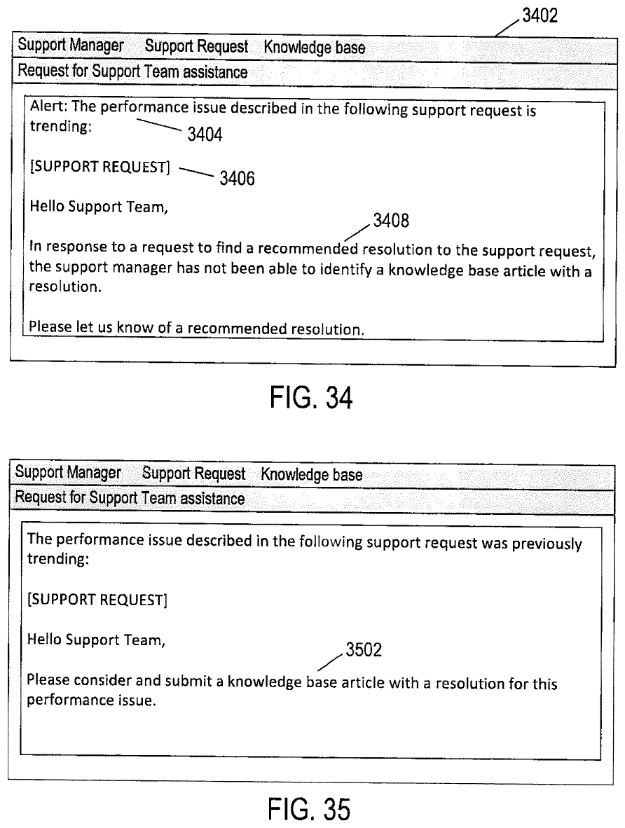

FIG. 34 shows a GUI 3402 of the support manager 1344 that displays an alert 3404 identifying the problem as trending and repeats the support request 3406. The GUI displays a request 3408 for someone on the support team to help identify a KB article with a resolution.

In certain cases, a new SR may not have similar SRs in the recent time window, but the feature vector of the new SR may be part of a cluster of feature vectors of previous recorded SRs that satisfy the similarity conditions. In other words, the new SR is part of a previously unidentified trending problem described in previously recorded SRs. In this situation, the support manager 1344 may request that the support team write a new KB article to address the previously recorded trend.

FIG. 35 shows a GUI 3502 of the support manager 1344 that displays a message identifying a previously unidentified trending problem. The GUI displays a request 3502 for someone on the support team to submit an KB article with a resolution to the problem.

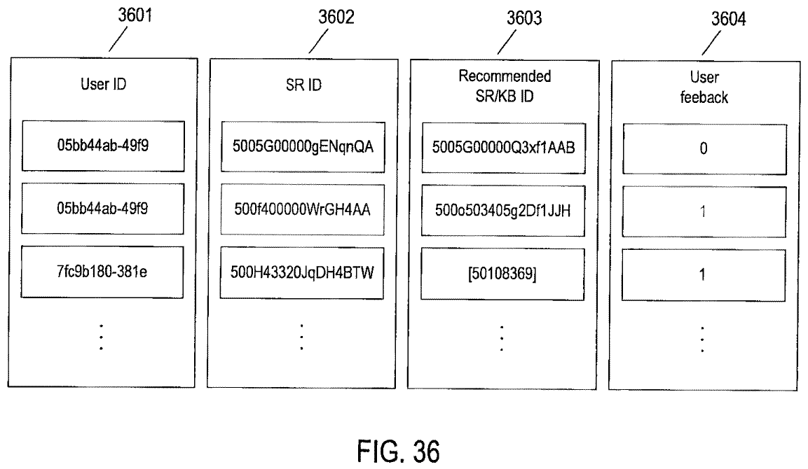

In one implementation, the support manager 1344 enables end users to submit user satisfaction information on the quality and/or relevance of recommended SRs and KB articles. FIG. 36 shows an example of user feedback information recorded for different recommended remedial measures associated with similar SRs and KB articles to a trending problem. Column 3601 contains IDs of end users who have submitted support requests of trending problems. The IDs of the support requests are listed in column 3602. The IDs of recommended remedial measures contained in the similar SRs and/or KB articles output from the support manager 1344 are listed in column 3603. Column 3604 lists the user feedback associated with each of the recommended remedial measures where a “1” represents the recommended remedial measures are “relevant” and “0” represents the recommended remedial measures are “not relevant.”

The support manager 1344 can use the user feedback to determine whether to display a recommended remedial measure. For example, when a trending problem is discovered, as described above, and the similar SR and/or KB article is identified a “0” user feedback, the support manager 1344 rejects displaying the recommended remedial measure associated with the similar SR and/or KB article.

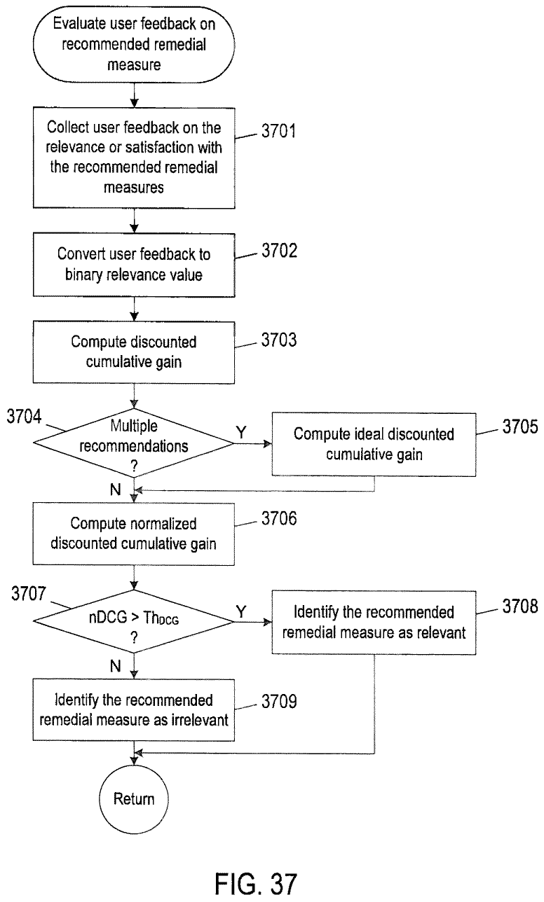

In another implementation, the support manager 1344 computes a normalized discounted cumulative gain (“nDCG”) score for recommended remedial measures to measure how well the recommended remedial measure aligns with the end user's preferences. FIG. 37 is a flow diagram of a method for computing the nDCG for a recommended remedial measure. In block 3701, the support manager 1344 collects user feedback on the relevance or satisfaction the end user has with the recommended remedial measures. For example, an end user may be presented with a GUI that enables the user to input a rating, such a relevant or not relevant, or poor, moderate, and good. The user feedback may also be implicit signals, such as number of clicks, number of purchases, or dwell time by the end user. In block 3702, the support manager 1344 converts the user feedback regarding the recommended remedial measures into a relevance value. For example, if the end user rates a recommended remedial measure with a relevance value of 3, 4, or 5 out of 5, the support manager 1344 converts these relevance values to “1,” which corresponds to relevant. On the other hand, if the relevance value is 0, 1, or a 2, the support manager 1344 converts the relevance values to “0,” which corresponds to irrelevant. In block 3703, the support manager 1344 computes the discounted cumulative gain for the recommended remedial measures as follows:

$$DCG = {\sum }_{i = 1}^{p} \frac{{rel}_{i}}{{log}_{2} ( i + 1 )} \qquad ( 11 )$$

where
   relᵢ is the relevance value of the i-th position (i.e., relᵢ={0,1})
   p is the number of user relevance ratings;
   i is the number or position of the rating.
      In decision block 3704, if there ae multiple recommended remedial measures, control flows to block 3705. Otherwise, control flows to block 3706 and nDCG=DCG. In block 3705, the support manager computes ideal discounted cumulative gain as follows:

$$IDCG = {\sum }_{i = 1}^{\vert {REL}_{p} \vert} \frac{{rel}_{i}}{{log}_{2} ( i + 1 )} \qquad ( 12 )$$

where RELₚ represents the list of recommended remedial measures order by relevance to the end user up to position p.
   In block 3706, the support manager 1344 computes the normalized discounted cumulative gain score for multiple recommended remedial measures as follows:

$$nDCG = \frac{DCG}{IDCG} \qquad ( 13 )$$

The nDCG score has a value between 0 and 1, where 1 represents a perfect recommendation, which means the end user found the recommended remedial measures most relevant, and 0 means the user did not find the recommended remedial relevant at all. The nDCG score is used to evaluate the quality of the individual recommended remedial measure. A high nDCG score indicates that the recommended remedial measure was more relevant and aligned with the end user's preferences than a lower nDCG score, which suggests that the user did not find the recommended remedial measures as relevant. In block 707, when the nDCG value obtained in block 3706 is greater than a DCG threshold, Th_{DCG} (e.g., Th_{DCG}=0.6 or 0.5), control flows to block 3708 in which the recommended remedial measure is identified as relevant. On the other hand, in block 3709, the recommended remedial measure is identified as irrelevant.

The nDCG score and user feedback can be used to personalize future recommendations for the end user. If the nDCG score is low, the support manager 1344 can be adjusting incorporate more relevant signals to improve the quality of future recommendations. The nDCG for an individual recommendation can be a valuable approach in cases where the support team wants to understand how well a single recommendation aligns with the user's preferences.

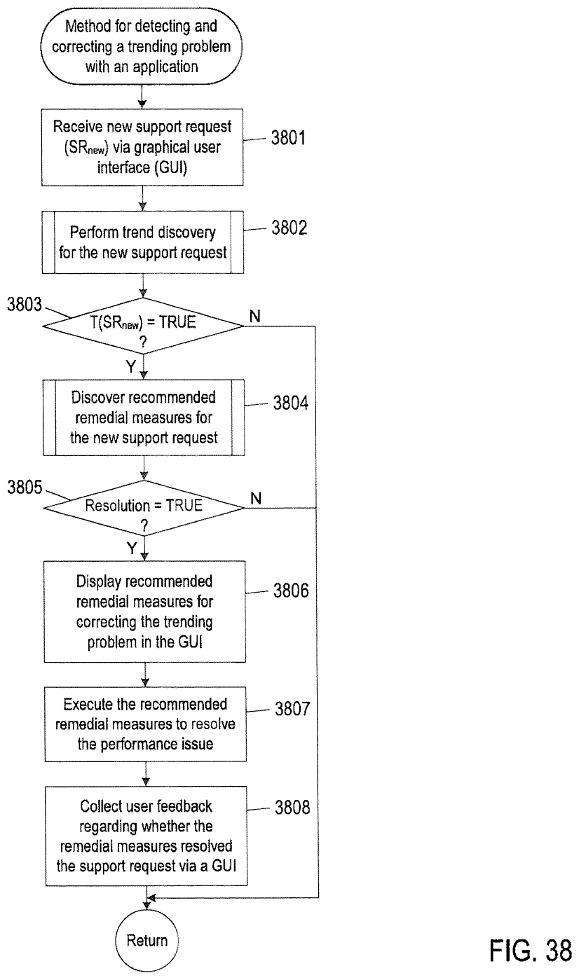

The methods described below with reference to FIGS. 38-42 are stored in one or more data-storage devices as machine-readable instructions and are executed by one or more processors of a computer system, such as the computer system shown in FIG. 1. The computer-implemented process described below eliminates human errors in discovering trending problems based on user created support requests submitted in natural language using a GUI. The processes significantly reduce the amount time spent discovering recommended remedial measures for trending problems from days and weeks to minutes and seconds, thereby providing immediate resolution of problems to end users.

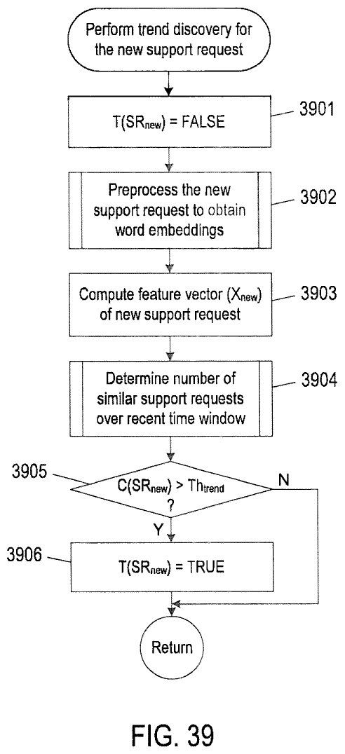

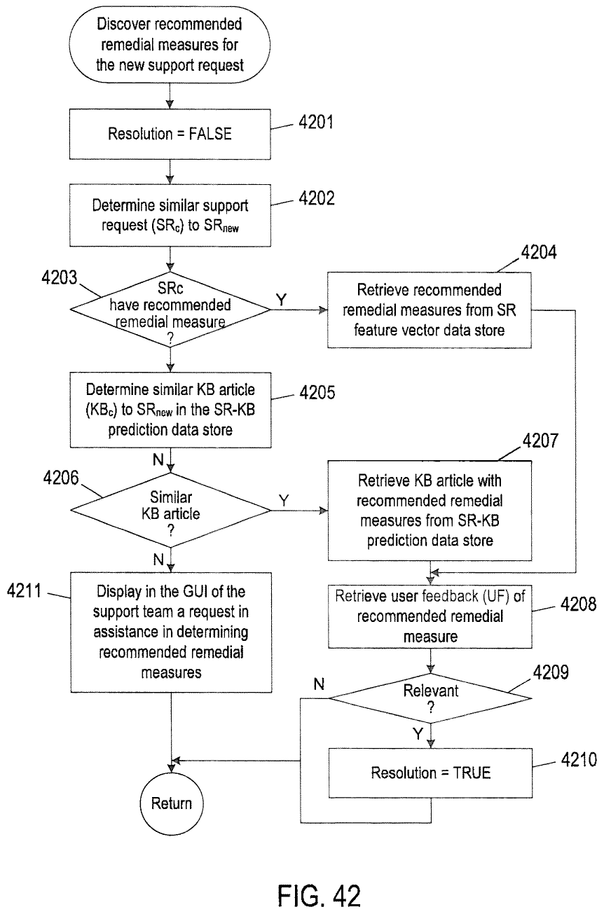

FIG. 38 is a flow diagram of a method for detecting and correcting a trending problem with an application executed in data center. In block 3801, a new support request is received via a GUI of the support manager 1344 as described above with reference to FIGS. 15A-15B. In block 3802, a “perform trend discovery of the new support request” procedure is performed. An example implementation of the “perform trend discovery of the new support request” is described below with reference to FIG. 39. In block 3803, if logic variable T(SR_{new}) set in the “perform trend discovery of the new support request” procedure is set to TRUE, control flows to block 3804. In block 3804, a “discover recommended remedial measures for the new support request” procedure is performed. An example implementation of the “discover recommended remedial measures for the new support request” is described below with reference to FIG. 42. In block 3805, if logic variable Resolution set in the “discover recommended remedial measures for the new support request” procedure is set to TRUE, control flows to block 3806. In block 3806, the recommended remedial measures for correcting the problems are displayed in a GUI, thereby enabling the end user to view the remedial measures. In block 3807, the recommended remedial measures for correcting the trending problem are executed using operations manager 1342. In block 3808, user feedback regarding whether the recommended remedial measure resolved the problem in the SR is collected via a GUI.

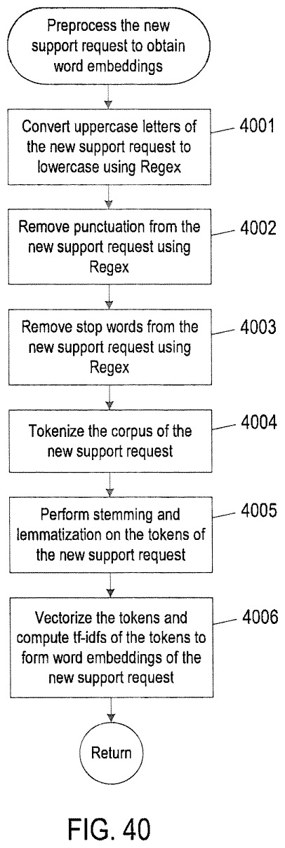

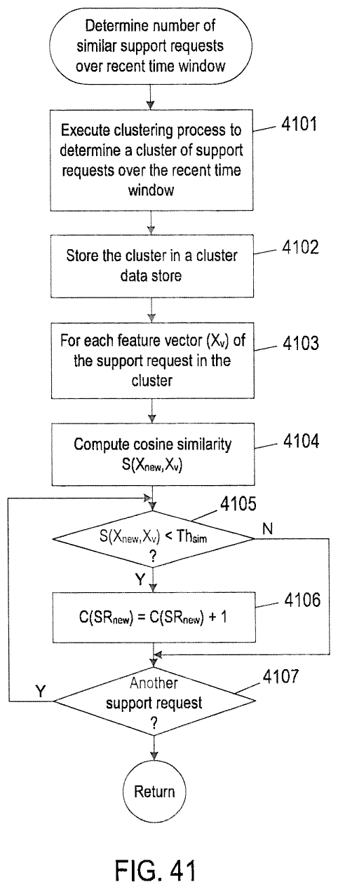

FIG. 39 is a flow diagram of the “perform trend discovery of the new support request” procedure performed in block 3802 of FIG. 38. In block 3901, the logic variable T(SR_{new}) is initialize to FALSE. The logic variable T(SR_{new}) indicates whether new SR is part of a trend in a recent time window. In block 3902, a “preprocess the new support request to obtain word embeddings” procedure is performed. An example implementation of the “preprocess the new support request to obtain word embeddings” is described below with reference to FIG. 40. In block 3903, a feature vector (X_{new}) is computed for the new SR using BERT as described above with reference to FIG. 23. In block 3904, a “determine number of similar support requests over recent time window” procedure is performed. An example implementation of the “determine number of similar support requests over recent time window” is described below with reference to FIG. 41. In decision block 3905, if the number of support request C(SR_{new}) (i.e., cardinality) is greater than the trend threshold in Equation (9), control flow to block 3906. In block 3906, the logic variable T(SR_{new}) is set to TRUE, indicating a trend in the SRs of the recent time window has been detected.

FIG. 40 is a flow diagram of the “preprocess the new support request to obtain word embeddings” procedure performed in block 3902 of FIG. 39. In block 4001, uppercase letters of the new support request are converted to lowercase using regular expressions (“Regexes”) as described above with reference to FIG. 18A. In block 4002, punction is removed from the new support request using Regexes as described above with reference to FIG. 18B. In block 4003, stop words are removed from the new support request using Regexes as described above with reference to FIG. 18C. In block 4004, tokenize the corpus of the new support request by removing urls, emails, etc as described above with reference to FIG. 18D. In block 4005, stemming and lemmatization are performed on the tokens as described above with reference to FIG. 18F. In block 4006, the tokens are vectorized and term frequency-inverse document frequencies are computed for tokens in the corpus as described above with reference to FIG. 19-22.

FIG. 41 is a flow diagram of the “determine number of similar support requests over recent time window” performed in block 3904 of FIG. 39. In block 4101, one of the K-means clustering or density-based clustering processes described above is performed to determine a cluster of support requests in the recent time window. In block 4102, the cluster of support requests is stored in cluster data store. A for loop beginning with block 4103, repeats the operations represented by blocks 4104 and 4105 for each feature vector of the support requests in the cluster. In block 4104, a cosine similar is computed between the feature vector of the new support request and the feature vector of the support request in the cluster. In decision block 4105, if the cosine similarity is less than the similarity threshold, control flow to block 4106. In block 4106, the counter of number of support request C(SR_{new}) in the cluster is incremented. In decision block 4107, blocks 4105 and 4106 are repeated for another support request in the cluster.

FIG. 42 is a flow diagram of the “discover recommended remedial measures for the new support request” performed in block 3804 of FIG. 38. In block 4201, the logic variable Resolution is set of FALSE, indicating a resolution to the trending problem has not yet been determined. In block 4202, determine a closest similar support request to the new support request in the SR feature vectors data store using cosine similarity of corresponding feature vectors. In decision block 4203, if the closest support request has corresponding recommended remedial measures, control flows to block 4204 in which the recommended remedial measures are retrieved from the data store. In block 4205, determine a closest similar KB article to the new support request in the SR-KB prediction data store using cosine similarity of corresponding feature vectors. In decision block 4206, if the KB article is similar to the new support request, control flows to block 4207 in which the KB article with recommended remedial measures is retrieved from the data store. In block 4208, retrieve use feedback of the recommended remedial measures. In decision block 4209, if the recommended remedial measures have been determined to relevant in a method for evaluating recommended remedial measures as described in FIG. 37, control flows to block 4210 in which the logic variable is set to TRUE. In block 4211, recommended remedial measures do not exist. The support manager 1344 request support team assistance as described above with reference to FIGS. 34 and 35.

It is appreciated that the previous description of the disclosed embodiments is provided to enable any person skilled in the art to make or use the present disclosure. Various modifications to these embodiments will be apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

1. An automated computer-implemented method for a method for detecting and correcting a trending problem with an application executing in a data center, the method comprising:
receiving a new support request entered via a graphical user interface (“GUI”) of a support manager;
performing trend discovery over a recent time window using a pre-trained and fine-tuned model bidirectional encoder representation from transformer that transforms token embeddings of the new support request to a feature vector;
in response to detecting a trending problem described in the new support request, discovering recommended remedial measures for the new support request based on similar support requests previously recorded in a support request data store or on similar knowledge base articles previously recorded a knowledge base data store;
executing the recommended remedial measures for correcting the trending problem using an operations manager of the data center; and
collecting user feedback regarding whether the recommended remedial measure resolved the trending problem.

2. The method of claim 1 wherein performing trend discovery over a recent time window comprises:
preprocess the new support request to obtain word embeddings of the new support request using regular expressions to extract tokens from the new support vector and term frequency-inverse domain frequency of the tokens;
inputting the word embeddings into the pre-trained and fine-tuned model bidirectional encoder representation from transformer to obtain a corresponding feature vector of the new support request;
determining a number of similar support requests to the new support request over the recent time window based on cosine similarity between the feature vector of the new support request and feature vectors of other previously created support requests recorded in the recent time window; and
identifying the new support request as corresponding to a trending problem in response to the number of similar support requests being greater than a trend threshold.

3. The method of claim 1 wherein determining the number of similar support requests to the new support request over a recent time window comprises:
using a clustering process to determine a cluster of support requests in the recent time window;
computing a cosine similar between the feature vector of the new support request and feature vectors of the support requests in the cluster;
counting the number of feature vectors with cosine similarity less than a similarity threshold; and
identifying the cluster as corresponding to the tending problem when the number of feature vectors in the cluster is greater than a trend threshold.

4. The method of claim 1 wherein discovering recommended remedial measures for the new support request based on similar support requests previously recorded in a support request data store or on similar knowledge base articles previously recorded in a knowledge base data store comprises:
determining a closest similar support request to the new support request in a SR feature vectors data store using cosine similarity of corresponding feature vectors;
if the closest support request has a corresponding recommended remedial measure, retrieving the recommended remedial measure from the SR feature vector data store;
determining a closest similar KB article to the new support request in the SR-KB prediction data store using cosine similarity of corresponding feature vectors;
if the KB article is similar to the new support request, retrieving the KB article with recommended remedial measure from the SR-KB prediction data store;
retrieve use feedback of the recommended remedial measures from a user feedback data store; and
if the recommended remedial measures have been determined to relevant, displaying the recommended remedial measures in a GUI.

5. The method of claim 1 further comprises:
collecting user feedback on relevance of a recommended remedial measures from an end user using a GUI;
converting the user feedback into a relevance value;
computing a discounted cumulative gain for the recommended remedial measures;
if there are multiple recommended remedial measures, computing an ideal discounted cumulative gain;
computes a normalized discounted cumulative gain score as the discounted cumulative gain divided by the ideal discounted cumulative gain; and
when the normalized discounted cumulative gain score is greater than a discounted cumulative threshold, identifying the recommended remedial measure as relevant.

6. A computer system for detecting and correcting a trending problem with an application executing in a data center, the computer system comprising:
one or more processors;
one or more data-storage devices; and
machine-readable instructions stored in the one or more data-storage devices that when executed using the one or more processors control the system to performance operations comprising:
receiving a new support request entered via a graphical user interface (“GUI”) of a support manager;
performing trend discovery over a recent time window using a pre-trained and fine-tuned model bidirectional encoder representation from transformer that transforms token embeddings of the new support request to a feature vector;
in response to detecting a trending problem described in the new support request, discovering recommended remedial measures for the new support request based on similar support requests previously recorded in a support request data store or on similar knowledge base articles previously recorded a knowledge base data store;
executing the recommended remedial measures for correcting the trending problem using an operations manager of the data center; and
collecting user feedback regarding whether the recommended remedial measure resolved the trending problem.

7. The system of claim 6 wherein performing trend discovery over a recent time window comprises:
preprocess the new support request to obtain word embeddings of the new support request using regular expressions to extract tokens from the new support vector and term frequency-inverse domain frequency of the tokens;
inputting the word embeddings into the pre-trained and fine-tuned model bidirectional encoder representation from transformer to obtain a corresponding feature vector of the new support request;
determining a number of similar support requests to the new support request over the recent time window based on cosine similarity between the feature vector of the new support request and feature vectors of other previously created support requests recorded in the recent time window; and
identifying the new support request as corresponding to a trending problem in response to the number of similar support requests being greater than a trend threshold.

8. The system of claim 6 wherein determining the number of similar support requests to the new support request over a recent time window comprises:
using a clustering process to determine a cluster of support requests in the recent time window;
computing a cosine similar between the feature vector of the new support request and feature vectors of the support requests in the cluster;
counting the number of feature vectors with cosine similarity less than a similarity threshold; and
identifying the cluster as corresponding to the tending problem when the number of feature vectors in the cluster is greater than a trend threshold.

9. The system of claim 6 wherein discovering recommended remedial measures for the new support request based on similar support requests previously recorded in a support request data store or on similar knowledge base articles previously recorded in a knowledge base data store comprises:
determining a closest similar support request to the new support request in a SR feature vectors data store using cosine similarity of corresponding feature vectors;
if the closest support request has a corresponding recommended remedial measure, retrieving the recommended remedial measure from the SR feature vector data store;
determining a closest similar KB article to the new support request in the SR-KB prediction data store using cosine similarity of corresponding feature vectors;
if the KB article is similar to the new support request, retrieving the KB article with recommended remedial measure from the SR-KB prediction data store;
retrieve use feedback of the recommended remedial measures from a user feedback data store; and
if the recommended remedial measures have been determined to relevant, displaying the recommended remedial measures in a GUI.

10. The system of claim 6 further comprises:
collecting user feedback on relevance of a recommended remedial measures from an end user using a GUI;
converting the user feedback into a relevance value;
computing a discounted cumulative gain for the recommended remedial measures;
if there are multiple recommended remedial measures, computing an ideal discounted cumulative gain;
computes a normalized discounted cumulative gain score as the discounted cumulative gain divided by the ideal discounted cumulative gain; and
when the normalized discounted cumulative gain score is greater than a discounted cumulative threshold, identifying the recommended remedial measure as relevant.

11. A non-transitory computer-readable medium having instructions encoded thereon for enabling one or more processors of a computer system to perform operations comprising:
receiving a new support request entered via a graphical user interface (“GUI”) of a support manager;
performing trend discovery over a recent time window using a pre-trained and fine-tuned model bidirectional encoder representation from transformer that transforms token embeddings of the new support request to a feature vector;
in response to detecting a trending problem described in the new support request, discovering recommended remedial measures for the new support request based on similar support requests previously recorded in a support request data store or on similar knowledge base articles previously recorded a knowledge base data store;
executing the recommended remedial measures for correcting the trending problem using an operations manager of the data center; and
collecting user feedback regarding whether the recommended remedial measure resolved the trending problem.

12. The medium of claim 11 wherein performing trend discovery over a recent time window comprises:
preprocess the new support request to obtain word embeddings of the new support request using regular expressions to extract tokens from the new support vector and term frequency-inverse domain frequency of the tokens;
inputting the word embeddings into the pre-trained and fine-tuned model bidirectional encoder representation from transformer to obtain a corresponding feature vector of the new support request;
determining a number of similar support requests to the new support request over the recent time window based on cosine similarity between the feature vector of the new support request and feature vectors of other previously created support requests recorded in the recent time window; and
identifying the new support request as corresponding to a trending problem in response to the number of similar support requests being greater than a trend threshold.

13. The medium of claim 11 wherein determining the number of similar support requests to the new support request over a recent time window comprises:
using a clustering process to determine a cluster of support requests in the recent time window;
computing a cosine similar between the feature vector of the new support request and feature vectors of the support requests in the cluster;
counting the number of feature vectors with cosine similarity less than a similarity threshold; and
identifying the cluster as corresponding to the tending problem when the number of feature vectors in the cluster is greater than a trend threshold.

14. The medium of claim 11 wherein discovering recommended remedial measures for the new support request based on similar support requests previously recorded in a support request data store or on similar knowledge base articles previously recorded in a knowledge base data store comprises:
determining a closest similar support request to the new support request in a SR feature vectors data store using cosine similarity of corresponding feature vectors;
if the closest support request has a corresponding recommended remedial measure, retrieving the recommended remedial measure from the SR feature vector data store;
determining a closest similar KB article to the new support request in the SR-KB prediction data store using cosine similarity of corresponding feature vectors;
if the KB article is similar to the new support request, retrieving the KB article with recommended remedial measure from the SR-KB prediction data store;
retrieve use feedback of the recommended remedial measures from a user feedback data store; and
if the recommended remedial measures have been determined to relevant, displaying the recommended remedial measures in a GUI.

15. The medium of claim 11 further comprises:
collecting user feedback on relevance of a recommended remedial measures from an end user using a GUI;
converting the user feedback into a relevance value;
computing a discounted cumulative gain for the recommended remedial measures;
if there are multiple recommended remedial measures, computing an ideal discounted cumulative gain;
computes a normalized discounted cumulative gain score as the discounted cumulative gain divided by the ideal discounted cumulative gain; and
when the normalized discounted cumulative gain score is greater than a discounted cumulative threshold, identifying the recommended remedial measure as relevant.
